(19) United States
(12) Patent Application Publication
(10) Pub. No.: US 2015/0346462 A1
(43) Pub. Date: Dec. 3, 2015

(54) OPTICAL IMAGING SYSTEM

(71) Applicant: NALUX CO., LTD., Osaka (JP)

(72) Inventor: Norifumi KANAI, Osaka (JP)

(21) Appl. No.: 14/821,877

(22) Filed: Aug. 10, 2015

Related U.S. Application Data
(63) Continuation of application No. PCT/JP2013/053988, filed on Feb. 19, 2013.

(51) Int. Cl. G02B 13/04

(52) U.S. Cl. CPC G02B 13/04

(57) ABSTRACT

Provided is a wide angle optical imaging system composed of four lenses, the wide angle optical imaging system allowing various types of aberrations including chromatic aberration of magnification to be sufficiently reduced. The wide angle optical imaging system includes the following arranged from the object side to the image plane side: a first lens that is a negative meniscus lens having a convex surface on the object side; a second lens that is negative; a third lens that is positive; an aperture stop; and a fourth lens that is positive, wherein the following expressions are satisfied, where v2, v3, and v4 represent Abbe numbers of materials that form the second to fourth lenses with respect to a d-line, respectively, f2 and f3 represent focal distances of the second and third lenses, respectively, and f represents a focal distance of the whole optical system: v2>35 (1) v3<45 (2) v4>35 (3) v2−v3≧10 (4) v4−v3≧10 (5) −2.3≦f2/f≦−1.5 (6) 3.0≦f3/f≦4.0 (7)

### TECHNICAL FIELD

The present invention relates to a wide-range optical imaging system including four lenses.

### BACKGROUND ART

Wide-range optical imaging systems are used in a wide application area such as surveillance cameras and vehicle-mounted cameras. Conventionally, most wide-range optical imaging systems having an F-number of 2.8 or less and a pixel account around three hundred thousand include five or six lenses. However, wide-range optical imaging systems including five or six lenses are not capable of responding to needs for further reducing the total weight and costs. A wide-range optical imaging system including four lenses has also been developed. Refer to JP2006259704A, for example. However, in the wide-range optical imaging system described in JP2006259704A, various types of aberrations including chromatic aberration of magnification cannot be reduced to a sufficient degree.

### PATENT DOCUMENT

Patent document 1: JP2006259704A

Accordingly, there is a need for a wide-range optical imaging system including four lenses, which allows various types of aberrations including chromatic aberration of magnification to be sufficiently reduced.

### SUMMARY OF INVENTION

A wide-range optical imaging system according to the present invention includes a first lens, a second lens, a third lens, an aperture stop, and a fourth lens, arranged from the object side to the image plane side, the first lens being a negative meniscus lens having a convex surface on the object side, the second lens being negative, the third lens being positive and the fourth lens being positive. When Abbe numbers for a d-line of the second to the fourth lenses are represented respectively by v₂, v₃ and v₄, the expressions

v2>35 (1)

v3<45 (2)

v4>35 (3)

v2−v3≧10 (4)

v4−v3≧10 (5)

are satisfied, and when a focal length of the second lens is represented as f2, a focal length of the third lens is represented as f3, and a focal length of the whole optical system is represented as f, the expressions

−2.3≦f2/f≦−1.5 (6)

3.0≦f3/f≦4.0 (7)

are satisfied.

When an arrangement of the four lenses and the aperture stop, an Abbe number and a focal length of each of the lenses, and a focal length of the whole optical system are determined as described above, an optical system that allows various types of aberrations including chromatic aberration of magnification to be sufficiently reduced and that can be easily manufactured, can be obtained.

In a wide-range optical imaging system according to a first embodiment of the present invention, the expressions

v2≧50 (8)

v3≦30 (9)

v4≧50 (10)

v2−v3≧20 (11)

v4−v3≧20 (12)

are further satisfied.

According to the present embodiment, chromatic aberration of magnification and longitudinal chromatic aberration can be further reduced.

A wide-range optical imaging system according to a second embodiment of the present invention is the above-described wide-range optical imaging system according to the present invention in which when a focal length of the fourth lens is represented as f4, the expression

1.72≦f4/f≦2.45 (13)

is satisfied.

In the wide-range optical imaging system according to the present embodiment, Expressions (6), (7) and (13) are simultaneously satisfied, and thereby chromatic aberration of magnification and longitudinal chromatic aberration are well balanced. When the value is lower than the lower limit of Expression (13), the manufacture and assembly of the fourth lens become difficult. When the value is greater than the upper limit of Expression (13), correction of various types of aberrations becomes difficult.

In a wide-range optical imaging system according to a third embodiment of the present invention, the image plane side surface of the second lens is concave, the object side surface of the third lens is convex, and the both surfaces of the fourth lens are convex.

According to the present embodiment, various types of aberrations can be efficiently corrected.

A wide-range optical imaging system according to a fourth embodiment of the present invention is the wide-range optical imaging system according to the third embodiment in which the edge of the object side surface of the second lens is configured to be warped toward the object side.

In the present embodiment, the configuration functions to bring the direction of a ray bundle with a greater angle of view close to the direction of the optical axis, and therefore the configuration has an advantage in its suitability for widening the angle of view.

Wide-range optical imaging systems according to the fifth and sixth embodiments of the present invention are the wide-range optical imaging systems of the third and fourth embodiments, respectively, in which the image plane side surface of the second lens and the object side surface of the third lens are configured such that among rays in a ray bundle that forms an image at the maximum image height, the further from the optical axis a position of a ray, the greater the traveling distance of the ray between the two surfaces around the edges of the two surfaces becomes.

The wide-range optical imaging systems according to the fifth and sixth embodiments have an advantage in its suitability for correcting comatic aberration of ray bundles that form an image around the maximum image height.

A wide-range optical imaging system according to a seventh embodiment of the present invention is the wide-range optical imaging system according to the sixth embodiment in which when a coordinate representing a position in the direction of the optical axis of a point on a lens surface with reference to the intersection point of the lens surface and the optical axis is represented as z, a sign of z is set to be positive on the image plane side, a distance between the point on the lens surface and the optical axis is represented as r, and the lens surface is represented as

z=f(r),

where f(x) represents a function of x, a sign of the second derivative of the above-described function around the optical axis of the image plane side surface of the second lens differs from a sign of the second derivative of the above-described function at the periphery of a circle having a diameter of 0.9 of the effective diameter of the image plane side surface of the second lens.

The wide-range optical imaging system according to the present embodiment has an advantage in its suitability for correcting comatic aberration of ray bundles that form an image around the maximum image height.

In a wide-range optical imaging system according to an eighth embodiment of the present invention, the expressions

−2.3≦f2/f≦−1.9 (14)

3.0≦f3/f≦3.5 (15)

are further satisfied.

In a wide-range optical imaging system according to a ninth embodiment of the present invention, the maximum angle of view (in full angle) is 170 degrees or more.

In a wide-range optical imaging system according to a tenth embodiment of the present invention, the maximum angle of view (in full angle) is 180 degrees or more.

### BRIEF DESCRIPTION OF DRAWINGS

FIG. 1 shows an arrangement of a wide-range optical imaging system according to Example 1;

FIGS. 2A to 2D show aberrations of the wide-range optical imaging system according to Example 1;

FIG. 3 shows an arrangement of a wide-range optical imaging system according to Example 2;

FIGS. 4A to 4D show aberrations of the wide-range optical imaging system according to Example 2;

FIG. 5 shows an arrangement of a wide-range optical imaging system according to Example 3;

FIGS. 6A to 6D show aberrations of the wide-range optical imaging system according to Example 3;

FIG. 7 shows an arrangement of a wide-range optical imaging system according to Example 4;

FIGS. 8A to 8D show aberrations of the wide-range optical imaging system according to Example 4;

FIG. 9 shows an arrangement of a wide-range optical imaging system according to Example 5;

FIGS. 10A to 10D show aberrations of the wide-range optical imaging system according to Example 5;

FIG. 11 shows an arrangement of a wide-range optical imaging system according to Example 6;

FIGS. 12A to 12D show aberrations of the wide-range optical imaging system according to Example 6;

FIG. 13 shows an arrangement of a wide-range optical imaging system according to Example 7;

FIGS. 14A to 14D show aberrations of the wide-range optical imaging system according to Example 7;

FIG. 15 shows an arrangement of a wide-range optical imaging system according to Example 8;

FIGS. 16A to 16D show aberrations of the wide-range optical imaging system according to Example 8;

FIG. 17 shows an arrangement of a wide-range optical imaging system according to Example 9;

FIGS. 18A to 18D show aberrations of the wide-range optical imaging system according to Example 9;

FIG. 19 shows an arrangement of a wide-range optical imaging system according to Example 10;

FIGS. 20A to 20D show aberrations of the wide-range optical imaging system according to Example 10;

FIG. 21 shows an arrangement of a wide-range optical imaging system according to Example 11;

FIGS. 22A to 22D show aberrations of the wide-range optical imaging system according to Example 11; and

FIG. 23 illustrates the ray bundle which travels between the image plane side surface of the second lens and the object side surface of the third lens and forms an image at the maximum image height.

### DESCRIPTION OF EMBODIMENTS

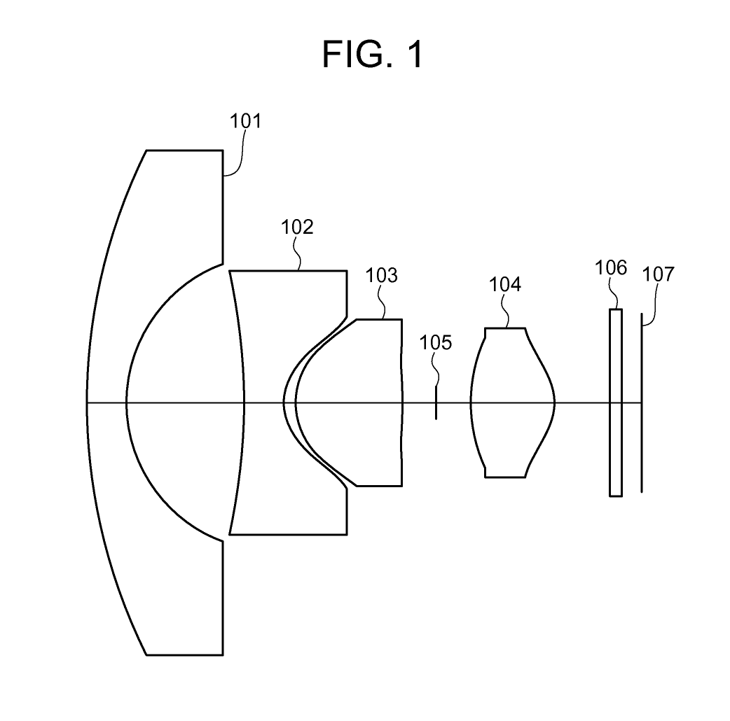

FIG. 1 shows an arrangement of a wide-range optical imaging system according to an embodiment of the present invention. The wide-range optical imaging system according to the present embodiment includes, from the object side to the image plane side, a first lens 101, a second lens 102, a third lens 103, an aperture stop 105, and a fourth lens 104. Light which has passed through the first lens 101, the second lens 102, the third lens 103, the aperture stop 105, and the fourth lens 104 passes through a glass plate 106 and reaches an image plane 107.

Features of the wide-range optical imaging system according to the present embodiment will be described below. In the following description, “i” represents an integer from 1 to 5, “fi” represents a focal length of the i-th lens, and “vi” represents an Abbe number of the material of the i-th lens at d line (wavelength of 587.6 nm).

### Types of the Four Lenses

The wide-range optical imaging system according to the present embodiment includes, from the object side to the image plane side, the first lens 101 which is a negative meniscus lens having a convex surface on the object side, the second lens 102 which is negative, the third lens 103 which is positive, the aperture stop 105, and the fourth lens 104 which is positive. The lens which is positive means a lens which has a positive power on the optical axis while the lens which is negative means a lens which has a negative power on the optical axis. Further, the convex surface means a lens surface which is convex to the air side around the vertex which is at the intersection point of the optical axis and the lens surface.

For wide-range optical imaging systems including four lenses, such an arrangement as described above in which a negative lens, a negative lens, a positive lens and a positive lens are arranged and an aperture stop is located between the third and fourth lenses is suited for reducing geometric aberrations except for distortion, chromatic aberration of magnification, and longitudinal chromatic aberration while balancing them.

Chromatic aberration of magnification is caused by dispersion of refractive index (an Abbes number) of a material of a lens. In the following combinations of two lenses, chromatic aberrations of magnifications described above are cancelled with each other.

1) A positive lens on the object side with reference to the aperture stop and a negative lens on the object side with reference to the aperture stop

2) A positive lens on the object side with reference to the aperture stop and a positive lens on the image plane side with reference to the aperture stop

3) A negative lens on the image plane side with reference to the aperture stop and a positive lens on the image plane side with reference to the aperture stop

4) A negative lens on the object side with reference to the aperture stop and a negative lens on the image plane side with reference to the aperture stop Further, since the whole optical imaging system has a positive power without fail, the composite focal length of the lenses of the former group (the first to the third lenses) is negative and its absolute value is greater than that of a focal length of the fourth lens or the composite focal length is positive. Under the above-described situation, an Abbe number of the material of the second lens which is included in the former group of lenses and has a relatively short focal length should preferably be greater than an Abbe number of the material of the third lens which is included in the former group of lenses. Further, an Abbe number of the material of the fourth lens should preferably be greater than an Abbe number of the material of the third lens. Thus, when Abbe numbers for d-line of the second to the fourth lenses are represented respectively by v₂, v₃ and v₄, it is preferable that the following expressions are satisfied.

v2>35 (1)

v3<45 (2)

v4>35(3)

v2−v3≧10 (4)

v4−v3≧10 (5)

Further, it is more preferable that the following expressions are satisfied.

v2≧50 (8)

v3≦30 (9)

v4≧50 (10)

v2−v3≧20 (11)

v4−v3≧20 (12)

All of Examples 1 to 11 satisfy the conditions concerning Abbe numbers expressed by Expressions (1) to (5) and those expressed by Expressions (8) to (12).

More specifically, the four lenses of Examples 1 to 11 are made of any of the following materials. However, the materials of the four lenses are not restricted to the following materials.

S-LAH65V: n=1.80400, v=46.57 (Ohara inc.)

S-NBH55: n=1.79999, v=29.84 (Ohara inc.)

ZEONEX 480R: n=1.52512, v=56.28 (Zeon)

PANLITE SP1516: n=1.61411, v=25.32 (Teijin)

“n” represents refractive index while “v” represents Abbe number.

Further, it is preferable that the image plane side surface of the second lens is concave, the object side surface of the third lens is convex, and the both surfaces of the fourth lens are convex. All of Examples 1 to 11 satisfy the above-described conditions.

The edge of the object side surface of the second lens should preferably be warped toward the object side. All of Examples 1 to 11 satisfy the above-described condition.

Further, the image plane side surface of the second lens and the object side surface of the third lens should preferably be configured such that among rays in a ray bundle which forms an image at the maximum image height, the further from the optical axis a position of a ray, the greater the traveling distance of the ray between the two surfaces around the edges of the two surfaces becomes.

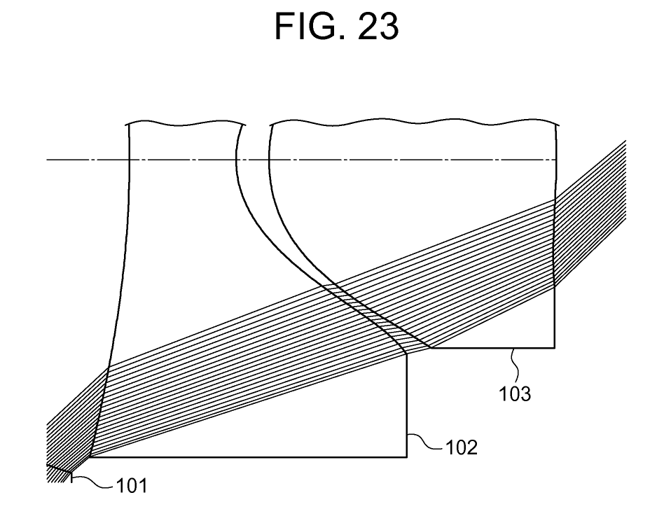

FIG. 23 illustrates the ray bundle which travels between the image plane side surface of the second lens and the object side surface of the third lens and forms an image at the maximum image height.

When a coordinate of a position in the direction of the optical axis of a point on a lens surface with reference to the intersection point of the lens surface and the optical axis is represented by z, a sign of z is set to be positive on the image plane side, a distance between the point on the lens surface and the optical axis is represented as r, and the lens surface is represented as

z=f(r),

where f(x) represents a function of x, a sign of the second derivative of the above-described function around the optical axis of the image plane side surface of the second lens should preferably differ from a sign of the second derivative of the above-described function at the periphery of a circle having a diameter of 0.9 of the effective diameter of the image plane side surface of the second lens. Examples 1 to 6 and Example 11 satisfy the above-described condition.

### Ratio of a Focal Length of the Second Lens to a Focal Length of the Whole Optical System and Ratio of a Focal Length of the Third Lens to the Focal Length of the Whole Optical System

Since aberrations of each lens around the maximum image height are significantly affected by aspheric terms of each lens, aberrations of the wide-range optical imaging system cannot be controlled by the focal length alone which is determined by the curvature at the center of the lens. However, when aberrations become greater at least in an area of image height in which an influence of the curvature at the center of a lens is predominant, an image quality in the area becomes worse, and in the outer area, aberrations become too great to be corrected by the aspheric surface. Accordingly, control of the curvature at the center of the lens (control of the focal length) is important.

Further, when types of the four lenses are selected as described above, the second lens and the third lens tend to become closer and the power of the second lens and the power of the third lens tend to become greater, and difficulties arise in the manufacture. If a focal length of the second lens and a focal length of the third lens are determined such that the following expressions are satisfied when the focal length of the second lens is represented as f2, the focal length of the third lens is represented as f3, and the focal length of the whole optical system is represented as f, aberrations can be corrected to a sufficient extent and at the same time the manufacture will become easier.

−2.3≦f2/f≦−1.5 (6)

3.0≦f3/f≦4.0 (7)

When the value is lower than the lower limit of Expression (6), correction of chromatic aberration of magnification becomes difficult. When the value is greater than the upper limit of Expression (6), the curvature of the lens becomes greater and therefore the manufacture becomes more difficult.

When the value is lower than the lower limit of Expression (7), the curvature of the lens becomes greater and therefore the manufacture becomes more difficult. When the value is greater than the upper limit of Expression (7), correction of chromatic aberration of magnification becomes difficult.

Further, it is more preferable that the following expressions are satisfied.

v2≧50 (8)

v3≦30 (9)

v4≧50 (10)

v2−v3≧20 (11)

v4−v3≧20 (12)

−2.3≦f2/f≦−1.9 (14)

3.0≦f3/f≦3.5 (15)

### Ratio of the Focal Length of the Fourth Lens to the Focal Length of the Whole Optical System

The following expression should preferably be satisfied when the focal length of the fourth lens is represented as f4 and the focal length of the whole optical system is represented as f,

1.72≦f4/f≦2.45 (13)

If Expressions (6), (7) and (13) are simultaneously satisfied, a balance between chromatic aberration of magnification and longitudinal chromatic aberration is achieved to a satisfactory extent. When the value is lower than the lower limit of Expression (13), the manufacture and assembly of the fourth lens becomes more difficult. When the value is greater than the upper limit of Expression (13), correction of various types of aberrations becomes difficult.

### Focal Length of Each Lens and Focal Length of the Whole Optical System Concerning Wide-Range Optical Imaging Systems According to Examples

Table 1 shows the focal length of each lens and the focal length of the whole optical system of each of wide-range optical imaging systems according to Examples 1 to 11. In each Example, an absolute value of the focal length of the second lens which is negative is smaller than an absolute value of the focal length of the third lens which is positive. Further, in each Example, an absolute value of the focal length of the fourth lens which is positive is smaller than an absolute value of the focal length of the third lens which is positive.

TABLE 1

| | f1 | f2 | f3 | f4 | f |
|---|---|---|---|---|---|
| Example 1 | −6.623 | −2.260 | 2.962 | 2.305 | 0.985 |
| Example 2 | −12.277 | −2.197 | 3.349 | 2.038 | 0.956 |
| Example 3 | −16.719 | −2.400 | 4.174 | 2.099 | 1.044 |
| Example 4 | −12.854 | −1.980 | 3.128 | 2.073 | 1.042 |
| Example 5 | −24.197 | −2.143 | 3.938 | 2.191 | 1.125 |
| Example 6 | −31.497 | −2.356 | 4.908 | 2.270 | 1.229 |
| Example 7 | −37.231 | −1.892 | 3.702 | 2.315 | 1.234 |
| Example 8 | −45.900 | −2.174 | 4.938 | 2.440 | 1.418 |
| Example 9 | −47.753 | −2.179 | 5.567 | 2.440 | 1.407 |
| Example 10 | −13.477 | −1.928 | 3.501 | 2.021 | 1.010 |
| Example 11 | −6.508 | −2.184 | 2.930 | 2.363 | 0.970 |

Table 2 shows a ratio of the focal length of the second lens to the focal length of the whole optical system, a ratio of the focal length of the third lens to the focal length of the whole optical system, and a ratio of the focal length of the fourth lens to the focal length of the whole optical system. In all the examples, Expression (6), Expression (7) and Expression (13) are satisfied. Further, in Examples 1, 4, 5, 10 and 11, Expression (14) and Expression (15) are satisfied.

TABLE 2

| | f2/f | f3/f | f4/f |
|---|---|---|---|
| Example 1 | −2.294 | 3.006 | 2.339 |
| Example 2 | −2.298 | 3.502 | 2.131 |
| Example 3 | −2.299 | 3.999 | 2.011 |
| Example 4 | −1.900 | 3.001 | 1.989 |
| Example 5 | −1.904 | 3.499 | 1.947 |
| Example 6 | −1.917 | 3.994 | 1.847 |
| Example 7 | −1.533 | 3.001 | 1.876 |
| Example 8 | −1.533 | 3.483 | 1.721 |
| Example 9 | −1.549 | 3.957 | 1.734 |
| Example 10 | −1.909 | 3.466 | 2.001 |
| Example 11 | −2.253 | 3.022 | 2.437 |

### Equation Representing Lens Surfaces of Examples

Surfaces of each lens in Examples can be expressed by the following equation.

$$z = \frac{{r}^{2} / R}{1 + \sqrt{1 - ( 1 + k ) {( r / R )}^{2}}} + {\sum }_{i = 4 , i even}^{12} {A}_{i} {r}^{i} \qquad ( A )$$

z represents a coordinate of a position in the direction of the optical axis of a point on a lens surface with reference to the intersection point of the lens surface and the optical axis. A sign of z is set to be positive on the image plane side. r represents a distance between the point on the lens surface and the optical axis. R represents the radius of curvature at the vertex of a lens surface. k represents a conic constant. Ai represents a coefficient of a polynomial.

### Example 1

FIG. 1 shows an arrangement of a wide-range optical imaging system according to Example 1. The wide-range optical imaging system according to Example 1 includes, from the object side to the image plane side, a first lens 101, a second lens 102, a third lens 103, an aperture stop 105, and a fourth lens 104. Light which has passed through the first lens 101, the second lens 102, the third lens 103, the aperture stop 105, and the fourth lens 104 passes through a glass plate 106 and reaches an image plane 107.

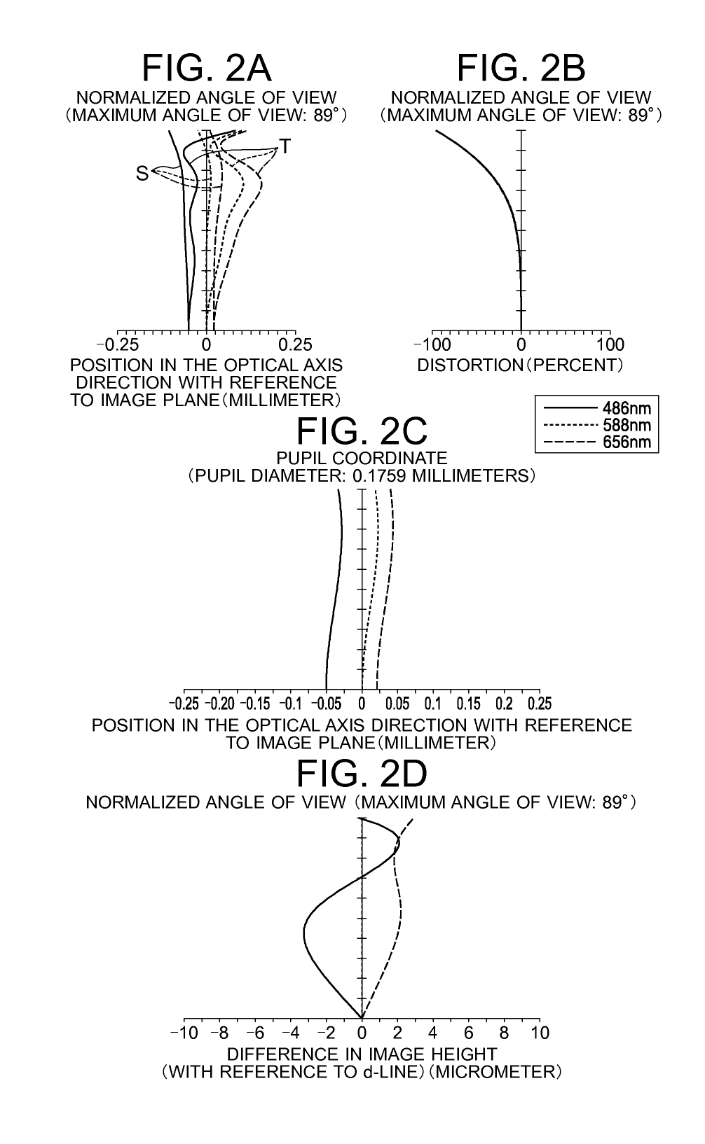

FIGS. 2A to 2D show aberrations of the wide-range optical imaging system according to Example 1. In the following drawings including FIGS. 2A to 2D, aberrations for F-line (wavelength of 486.1 nm), d-line (wavelength of 587.6 nm) and C-line (wavelength of 656.3 nm) are shown. FIG. 2A shows astigmatism. In FIG. 2A, distance (in millimeters) from the image plane to the paraxial image surface is represented as a function of normalized angle of view. The maximum value of normalized angle of view corresponds to 89 degrees. In FIG. 2A, S represents the sagittal image surface while T represents the tangential image surface. FIG. 2B shows distortion. In FIG. 2B, distortion is represented as a function of normalized angle of view. The maximum value of normalized angle of view corresponds to 89 degrees. FIG. 2C shows spherical aberration. In FIG. 2C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.1759 millimeters. FIG. 2D shows chromatic aberration of magnification. In FIG. 2D, image height difference (in micrometer) of each of F-line and C-line with reference to image height of d-line is represented as a function of normalized angle of view. The maximum value of normalized angle of view corresponds to 89 degrees.

Table 3 shows lens data of the wide-range optical imaging system according to Example 1. Surface numbers 1 to 6 represent the object side surface and the image plane side surface of each of the first lens 101, the second lens 102 and the third lens 103, respectively. Surface number 7 represents the aperture stop 105. Surface numbers 8 and 9 represent the object side surface and the image plane side surface of the fourth lens 104, respectively. Surface number 10 represents the object side surface of the glass plate 106, and surface number 11 represents the image plane side surface of the glass plate 106. R represents the radius of curvature in Equation (A) which represents each lens surface. d represents thickness of a lens or the glass plate or distance between elements. By way of example, the value of d (1.00000) in the row of surface number 1 represents thickness of the first lens 101, and the value of d (2.98304) in the row of surface number 2 represents distance between the first lens 101 and the second lens 102. n represents refractive index at d-line of each lens or element, and v represents an Abbe number at d-line of the material of each lens or element. Unit of length in Table 3 is millimeter.

TABLE 3

| Surface | | | | |
|---|---|---|---|---|
| number | R | d | n | v |
| 1 | 14.30900 | 1.00000 | 1.80400 | 46.57 |
| 2 | 3.76000 | 2.98304 | | |
| 3 | −13.91776 | 1.00000 | 1.52512 | 56.28 |
| 4 | 1.32965 | 0.30848 | | |
| 5 | 2.08119 | 2.69443 | 1.61411 | 25.32 |
| 6 | −7.31663 | 0.85448 | | |
| 7 | ∞ | 0.87937 | | |
| 8 | 4.10996 | 2.10864 | 1.52512 | 56.28 |
| 9 | −1.41234 | 1.41210 | | |
| 10 | ∞ | 0.30000 | 1.51680 | 64.17 |
| 11 | ∞ | 0.50000 | | |

Table 4 shows conic constants and coefficients of the polynomials of the Equation (A) representing the both surfaces of the second to the fourth lenses of Example 1. Since the both surfaces of the first lens 101 are spherical, the conic constants k and the coefficients of the polynomials Ai are zero.

TABLE 4

| Surface | | | | | | |
|---|---|---|---|---|---|---|
| number | k | α4 | α6 | α8 | α10 | α12 |
| 3 | -5.10116E+01 | −2.33742E−03 | 2.40285E−04 | −9.32063E−06 | 0.00000E+00 | 0.00000E+00 |
| 4 | −7.29698E−01 | 5.40020E−03 | −1.83818E−03 | −1.72344E−03 | 5.56873E−05 | 6.01837E−06 |
| 5 | −3.78734E−01 | 3.99271E−02 | −4.55267E−03 | −5.33569E−04 | 0.00000E+00 | 0.00000E+00 |
| 6 | −2.67688E+02 | 9.31244E−03 | 9.05869E−04 | 0.00000E+00 | 0.00000E+00 | 0.00000E+00 |
| 8 | −3.74056E+00 | 6.59283E−03 | 2.01226E−04 | 0.00000E+00 | 0.00000E+00 | 0.00000E+00 |
| 9 | −1.42444E+00 | 2.20175E−02 | 2.48032E−03 | −3.09279E−04 | 0.00000E+00 | 0.00000E+00 |

### Example 2

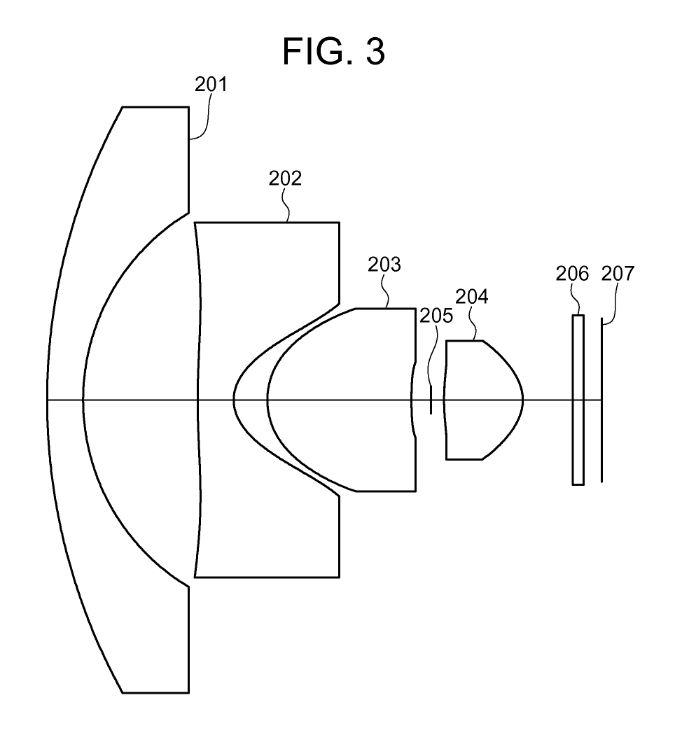

FIG. 3 shows an arrangement of a wide-range optical imaging system according to Example 2. The wide-range optical imaging system according to Example 2 includes, from the object side to the image plane side, a first lens 201, a second lens 202, a third lens 203, an aperture stop 205, and a fourth lens 204. Light which has passed through the first lens 201, the second lens 202, the third lens 203, the aperture stop 205, and the fourth lens 204 passes through a glass plate 206 and reaches an image plane 207.

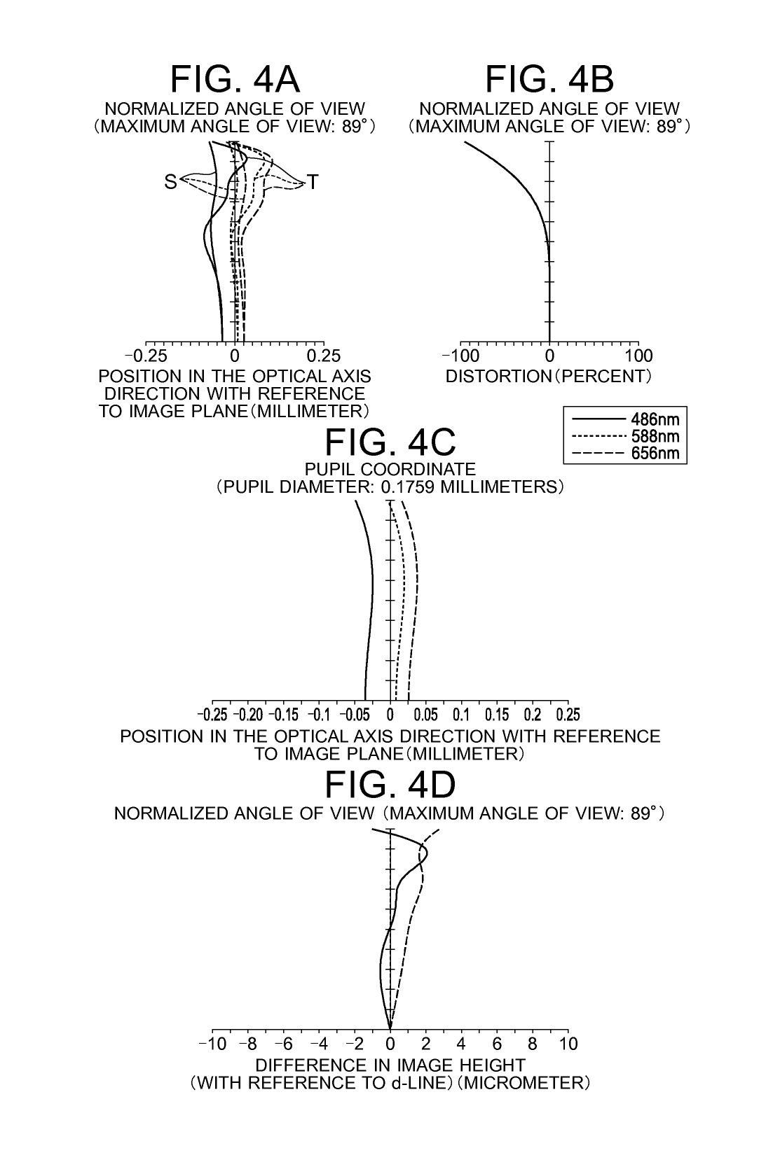

FIGS. 4A to 4D show aberrations of the wide-range optical imaging system according to Example 2. FIG. 4A shows astigmatism. In FIG. 4A, distance (in millimeters) from the image plane to the paraxial image surface is represented as a function of normalized angle of view. The maximum value of normalized angle of view corresponds to 89 degrees. In FIG. 4A, S represents the sagittal image surface while T represents the tangential image surface. FIG. 4B shows distortion. In FIG. 4B, distortion is represented as a function of normalized angle of view. The maximum value of normalized angle of view corresponds to 89 degrees. FIG. 4C shows spherical aberration. In FIG. 4C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.1708 millimeters. FIG. 4D shows chromatic aberration of magnification. In FIG. 4D, image height difference (in micrometer) of each of F-line and C-line with reference to image height of d-line is represented as a function of normalized angle of view. The maximum value of normalized angle of view corresponds to 89 degrees.

Table 5 shows lens data of the wide-range optical imaging system according to Example 2. Surface numbers 1 to 6 represent the object side surface and the image plane side surface of each of the first lens 201, the second lens 202 and the third lens 203, respectively. Surface number 7 represents the aperture stop 205. Surface numbers 8 and 9 represent the object side surface and the image plane side surface of the fourth lens 204, respectively. Surface number 10 represents the object side surface of the glass plate 206, and surface number 11 represents the image plane side surface of the glass plate 206. R represents the radius of curvature in Equation (A) which represents each lens surface. d represents thickness of a lens or the glass plate, or distance between elements. By way of example, the value of d (1.00000) in the row of surface number 1 represents thickness of the first lens 201, and the value of d (3.17972) in the row of surface number 2 represents distance between the first lens 201 and the second lens 202. n represents refractive index at d-line of each lens or element, and v represents an Abbe number at d-line of the material of each lens or element. Unit of length in Table 5 is millimeter.

TABLE 5

| Surface | | | | |
|---|---|---|---|---|
| number | R | d | n | v |
| 1 | 16.75588 | 1.00000 | 1.80400 | 46.57 |
| 2 | 6.04641 | 3.17972 | | |
| 3 | 20.38928 | 1.00000 | 1.52512 | 56.28 |
| 4 | 1.07351 | 0.93491 | | |
| 5 | 1.98129 | 4.00003 | 1.61411 | 25.32 |
| 6 | 12.55009 | 0.53850 | | |
| 7 | ∞ | 0.36557 | | |
| 8 | 5.06355 | 2.18712 | 1.52512 | 56.28 |
| 9 | −1.15501 | 1.38990 | | |
| 10 | ∞ | 0.30000 | 1.51680 | 64.17 |
| 11 | ∞ | 0.50000 | | |

Table 6 shows conic constants and coefficients of the polynomials of the Equation (A) representing the both surfaces of the second to the fourth lenses of Example 2. Since the both surfaces of the first lens 201 are spherical, the conic constants k and the coefficients of the polynomials Ai are zero.

TABLE 6

| Surface | | | | | | |
|---|---|---|---|---|---|---|
| number | k | α4 | α6 | α8 | α10 | α12 |
| 3 | 0.00000E+00 | −2.37145E−03 | 6.68848E−05 | −7.05904E−07 | 0.00000E+00 | 0.00000E+00 |
| 4 | −8.99384E−01 | 4.32445E−03 | −5.20968E−04 | −1.08167E−03 | 1.07817E−04 | −3.08204E−06 |
| 5 | −4.63562E−01 | 9.89755E−03 | 8.49346E−05 | −2.14724E−04 | 0.00000E+00 | 0.00000E+00 |
| 6 | 0.00000E+00 | 4.24028E−02 | 1.20781E−02 | 0.00000E+00 | 0.00000E+00 | 0.00000E+00 |
| 8 | −1.55413E+02 | 3.26018E−02 | −2.21010E−02 | 0.00000E+00 | 0.00000E+00 | 0.00000E+00 |
| 9 | −6.10821E−01 | 4.88710E−02 | −1.29661E−03 | 2.81440E−03 | 0.00000E+00 | 0.00000E+00 |

### Example 3

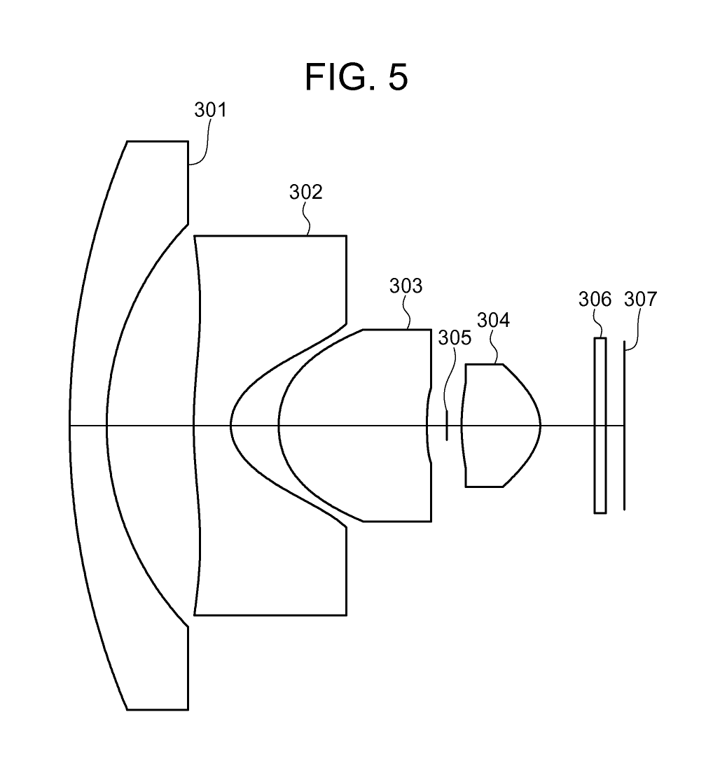

FIG. 5 shows an arrangement of a wide-range optical imaging system according to Example 3. The wide-range optical imaging system according to Example 3 includes, from the object side to the image plane side, a first lens 301, a second lens 302, a third lens 303, an aperture stop 305, and a fourth lens 304. Light which has passed through the first lens 301, the second lens 302, the third lens 303, the aperture stop 305, and the fourth lens 304 passes through a glass plate 306 and reaches an image plane 307.

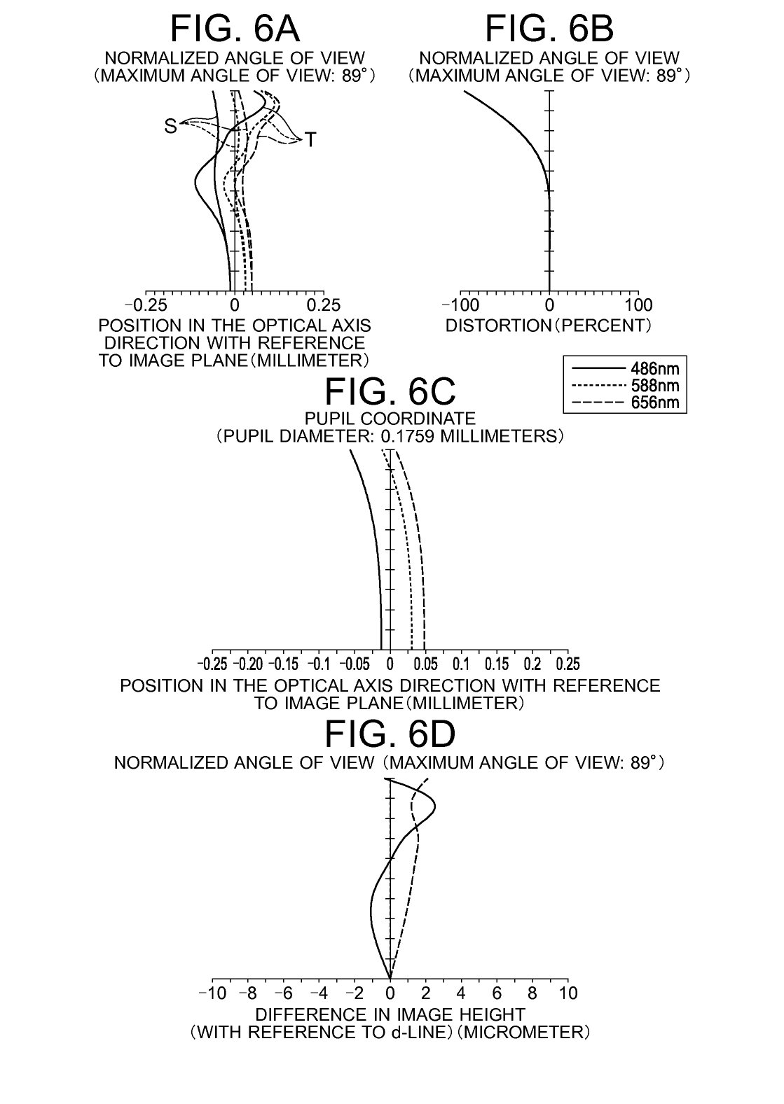

FIGS. 6A to 6D show aberrations of the wide-range optical imaging system according to Example 3. FIG. 6A shows astigmatism. In FIG. 6A, distance (in millimeters) from the image surface to the paraxial image surface is represented as a function of normalized angle of view. The maximum value of normalized angle of view corresponds to 89 degrees. In FIG. 6A, S represents the sagittal image surface while T represents the tangential image surface. FIG. 6B shows distortion. In FIG. 6B, distortion is represented as a function of normalized angle of view. The maximum value of normalized angle of view corresponds to 89 degrees. FIG. 6C shows spherical aberration. In FIG. 6C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.1864 millimeters. FIG. 6D shows chromatic aberration of magnification. In FIG. 6D, image height difference (in micrometer) of each of F-line and C-line with reference to image height of d-line is represented as a function of normalized angle of view. The maximum value of normalized angle of view corresponds to 89 degrees.

Table 7 shows lens data of the wide-range optical imaging system according to Example 3. Surface numbers 1 to 6 represent the object side surface and the image plane side surface of each of the first lens 301, the second lens 302 and the third lens 303, respectively. Surface number 7 represents the aperture stop 305. Surface numbers 8 and 9 represent the object side surface and the image plane side surface of the fourth lens 304, respectively. Surface number 10 represents the object side surface of the glass plate 306, and surface number 11 represents the image plane side surface of the glass plate 306. R represents the radius of curvature in Equation (A) which represents each lens surface. d represents thickness of a lens or the glass plate, or distance between elements. By way of example, the value of d (1.00000) in the row of surface number 1 represents thickness of the first lens 301, and the value of d (2.34677) in the row of surface number 2 represents distance between the first lens 301 and the second lens 302. n represents refractive index at d-line of each lens or element, and v represents an Abbe number at d-line of the material of each lens or element. Unit of length in Table 7 is millimeter.

TABLE 7

| Surface | | | | |
|---|---|---|---|---|
| number | R | d | n | v |
| 1 | 19.62909 | 1.00000 | 1.80400 | 46.57 |
| 2 | 7.79721 | 2.34677 | | |
| 3 | 12.53754 | 1.00000 | 1.52512 | 56.28 |
| 4 | 1.11358 | 1.29204 | | |
| 5 | 2.34739 | 3.99993 | 1.61411 | 25.32 |
| 6 | 9.79945 | 0.53876 | | |
| 7 | ∞ | 0.39578 | | |
| 8 | 4.79310 | 2.12255 | 1.52512 | 56.28 |
| 9 | −1.21291 | 1.46755 | | |
| 10 | ∞ | 0.30000 | 1.51680 | 64.17 |
| 11 | ∞ | 0.50000 | | |

Table 8 shows conic constants and coefficients of the polynomials of the Equation (A) representing the both surfaces of the second to the fourth lenses of Example 3. Since the both surfaces of the first lens 301 are spherical, the conic constants k and the coefficients of the polynomials Ai are zero.

TABLE 8

| Surface | | | | | | |
|---|---|---|---|---|---|---|
| number | k | α4 | α6 | α8 | α10 | α12 |
| 3 | 0.00000E+00 | −2.97406E−03 | 7.09798E−05 | −6.63820E−07 | 0.00000E+00 | 0.00000E+00 |
| 4 | −8.87458E−01 | 1.13754E−02 | −2.30953E−04 | −1.20153E−03 | 1.13226E−04 | −3.46288E−06 |
| 5 | −4.46515E−01 | 1.35420E−02 | 1.73996E−04 | −8.86447E−05 | 0.00000E+00 | 0.00000E+00 |
| 6 | 0.00000E+00 | 4.43072E−02 | 9.81984E−03 | 0.00000E+00 | 0.00000E+00 | 0.00000E+00 |
| 8 | −5.80087E+01 | 1.83295E−02 | −4.23490E−03 | 0.00000E+00 | 0.00000E+00 | 0.00000E+00 |
| 9 | −9.05465E−01 | 2.14000E−02 | 3.11502E−04 | 3.80733E−05 | 0.00000E+00 | 0.00000E+00 |

### Example 4

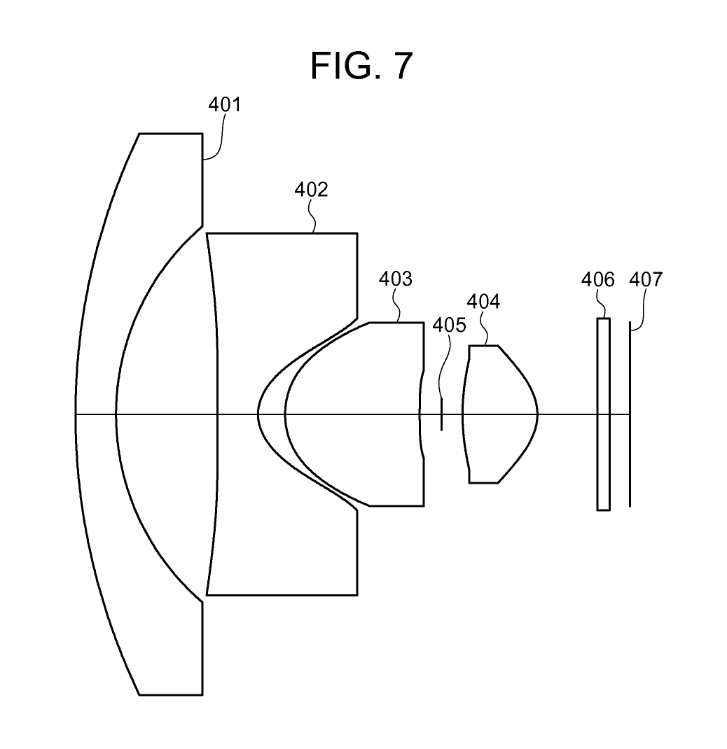

FIG. 7 shows an arrangement of a wide-range optical imaging system according to Example 4. The wide-range optical imaging system according to Example 4 includes, from the object side to the image plane side, a first lens 401, a second lens 402, a third lens 403, an aperture stop 405, and a fourth lens 404. Light which has passed through the first lens 401, the second lens 402, the third lens 403, the aperture stop 405, and the fourth lens 404 passes through a glass plate 406 and reaches an image plane 407.

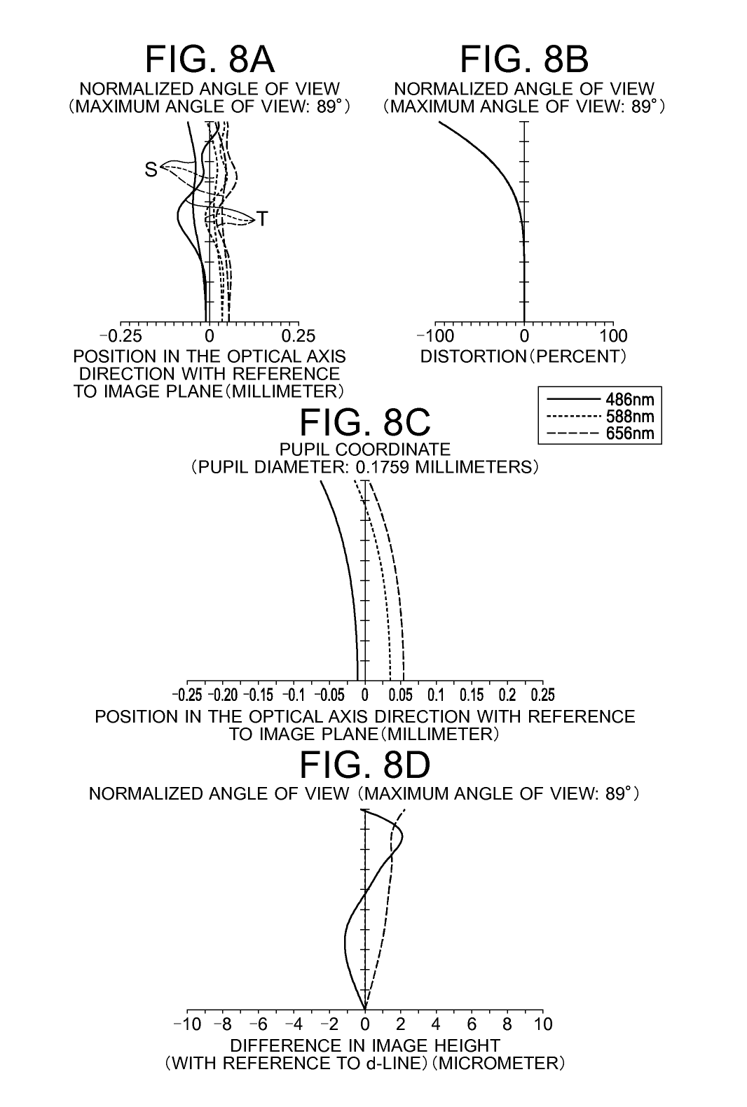

FIGS. 8A to 8D show aberrations of the wide-range optical imaging system according to Example 4. FIG. 8A shows astigmatism. In FIG. 8A, distance (in millimeters) from the image plane to the paraxial image surface is represented as a function of normalized angle of view. The maximum value of normalized angle of view corresponds to 89 degrees. In FIG. 8A, S represents the sagittal image surface while T represents the tangential image surface. FIG. 8B shows distortion. In FIG. 8B, distortion is represented as a function of normalized angle of view. The maximum value of normalized angle of view corresponds to 89 degrees. FIG. 8C shows spherical aberration. In FIG. 8C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.1861 millimeters. FIG. 8D shows chromatic aberration of magnification. In FIG. 8D, image height difference (in micrometer) of each of F-line and C-line with reference to image height of d-line is represented as a function of normalized angle of view. The maximum value of normalized angle of view corresponds to 89 degrees.

Table 9 shows lens data of the wide-range optical imaging system according to Example 4. Surface numbers 1 to 6 represent the object side surface and the image plane side surface of each of the first lens 401, the second lens 402 and the third lens 403, respectively. Surface number 7 represents the aperture stop 405. Surface numbers 8 and 9 represent the object side surface and the image plane side surface of the fourth lens 404, respectively. Surface number 10 represents the object side surface of the glass plate 406, and surface number 11 represents the image plane side surface of the glass plate 406. R represents the radius of curvature in Equation (A) which represents each lens surface. d represents thickness of a lens or the glass plate, or distance between elements. By way of example, the value of d (1.00000) in the row of surface number 1 represents thickness of the first lens 401, and the value of d (2.50237) in the row of surface number 2 represents distance between the first lens 401 and the second lens 402. n represents refractive index at d-line of each lens or element, and v represents an Abbe number at d-line of the material of each lens or element. Unit of length in Table 9 is millimeter.

TABLE 9

| Surface | | | | |
|---|---|---|---|---|
| number | R | d | n | v |
| 1 | 15.91688 | 1.00000 | 1.80400 | 46.57 |
| 2 | 6.09058 | 2.50237 | | |
| 3 | 160.21972 | 1.00000 | 1.52512 | 56.28 |
| 4 | 1.03064 | 0.66806 | | |
| 5 | 1.88037 | 3.31803 | 1.61411 | 25.32 |
| 6 | 29.42935 | 0.54246 | | |
| 7 | ∞ | 0.51420 | | |
| 8 | 5.03929 | 1.84639 | 1.52512 | 56.28 |
| 9 | −1.21354 | 1.48108 | | |
| 10 | ∞ | 0.30000 | 1.51680 | 64.17 |
| 11 | ∞ | 0.50000 | | |

Table 10 shows conic constants and coefficients of the polynomials of the Equation (A) representing the both surfaces of the second to the fourth lenses of Example 4. Since the both surfaces of the first lens 401 are spherical, the conic constants k and the coefficients of the polynomials Ai are zero.

TABLE 10

| Surface | | | | | | |
|---|---|---|---|---|---|---|
| number | k | α4 | α6 | α8 | α10 | α12 |
| 3 | 0.00000E+00 | −2.29338E−03 | 1.14565E−04 | −2.13709E−06 | −3.36485E−09 | 2.99138E−10 |
| 4 | −8.62930E−01 | 8.59319E−03 | −3.07143E−03 | −1.40132E−03 | 1.08601E−04 | −2.05266E−06 |
| 5 | −4.08338E−01 | 2.06693E−02 | −1.53245E−04 | −5.72967E−04 | 0.00000E+00 | 0.00000E+00 |
| 6 | 0.00000E+00 | 6.82525E−02 | −3.10800E−02 | 2.10858E−02 | 0.00000E+00 | 0.00000E+00 |
| 8 | −1.31816E+01 | 1.09535E−03 | 2.27488E−03 | −7.47524E−04 | 0.00000E+00 | 0.00000E+00 |
| 9 | −1.95324E+00 | −4.29912E−02 | 1.73545E−02 | −2.29586E−03 | 0.00000E+00 | 0.00000E+00 |

### Example 5

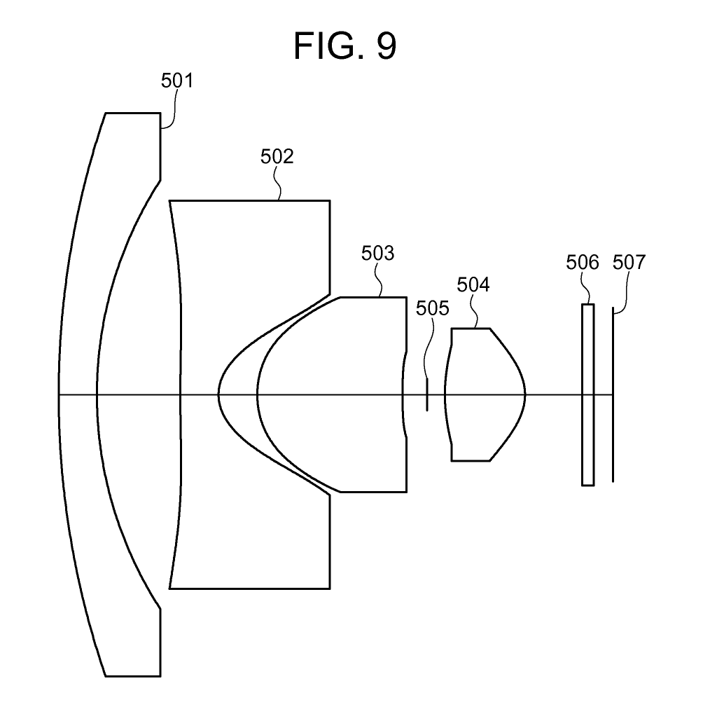

FIG. 9 shows an arrangement of a wide-range optical imaging system according to Example 5. The wide-range optical imaging system according to Example 5 includes, from the object side to the image plane side, a first lens 501, a second lens 502, a third lens 503, an aperture stop 505, and a fourth lens 504. Light which has passed through the first lens 501, the second lens 502, the third lens 503, the aperture stop 505, and the fourth lens 504 passes through a glass plate 506 and reaches an image plane 507.

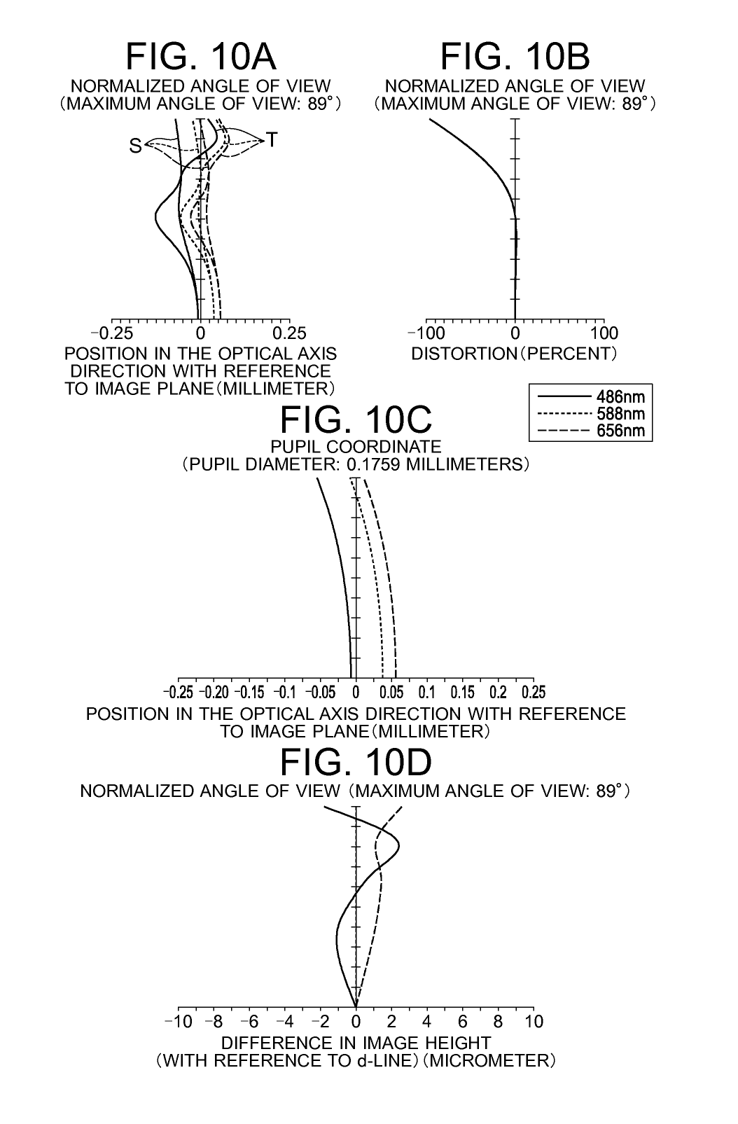

FIGS. 10A to 10D show aberrations of the wide-range optical imaging system according to Example 5. FIG. 10A shows astigmatism. In FIG. 10A, distance (in millimeters) from the image plane to the paraxial image surface is represented as a function of normalized angle of view. The maximum value of normalized angle of view corresponds to 89 degrees. In FIG. 10A, S represents the sagittal image surface while T represents the tangential image surface. FIG. 10B shows distortion. In FIG. 10B, distortion is represented as a function of normalized angle of view. The maximum value of normalized angle of view corresponds to 89 degrees. FIG. 10C shows spherical aberration. In FIG. 10C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.2010 millimeters. FIG. 10D shows chromatic aberration of magnification. In FIG. 10D, image height difference (in micrometer) of each of F-line and C-line with reference to image height of d-line is represented as a function of normalized angle of view. The maximum value of normalized angle of view corresponds to 89 degrees.

Table 11 shows lens data of the wide-range optical imaging system according to Example 5. Surface numbers 1 to 6 represent the object side surface and the image plane side surface of each of the first lens 501, the second lens 502 and the third lens 503, respectively. Surface number 7 represents the aperture stop 505. Surface numbers 8 and 9 represent the object side surface and the image plane side surface of the fourth lens 504, respectively. Surface number 10 represents the object side surface of the glass plate 506, and surface number 11 represents the image plane side surface of the glass plate 506. R represents the radius of curvature in Equation (A) which represents each lens surface. d represents thickness of a lens or the glass plate, or distance between elements. By way of example, the value of d (1.00000) in the row of surface number 1 represents thickness of the first lens 501, and the value of d (2.18306) in the row of surface number 2 represents distance between the first lens 501 and the second lens 502. n represents refractive index at d-line of each lens or element, and v represents an Abbe number at d-line of the material of each lens or element. Unit of length in Table 11 is millimeter.

TABLE 11

| Surface | | | | |
|---|---|---|---|---|
| number | R | d | n | v |
| 1 | 22.60925 | 1.00000 | 1.80400 | 46.57 |
| 2 | 10.25067 | 2.18306 | | |
| 3 | 41.30378 | 1.00000 | 1.52512 | 56.28 |
| 4 | 1.08638 | 1.01308 | | |
| 5 | 2.32120 | 3.80062 | 1.61411 | 25.32 |
| 6 | 21.77173 | 0.63863 | | |
| 7 | ∞ | 0.46823 | | |
| 8 | 4.16310 | 2.09637 | 1.52512 | 56.28 |
| 9 | −1.31436 | 1.49962 | | |
| 10 | ∞ | 0.30000 | 1.51680 | 64.17 |
| 11 | ∞ | 0.50000 | | |

Table 12 shows conic constants and coefficients of the polynomials of the Equation (A) representing the both surfaces of the second to the fourth lenses of Example 5. Since the both surfaces of the first lens 501 are spherical, the conic constants k and the coefficients of the polynomials Ai are zero.

TABLE 12

| Surface | | | | | | |
|---|---|---|---|---|---|---|
| number | k | α4 | α6 | α8 | α10 | α12 |
| 3 | 0.00000E+00 | −2.10637E−03 | 6.50201E−05 | −7.07830E−07 | 0.00000E+00 | 0.00000E+00 |
| 4 | −8.78518E−01 | 6.85384E−03 | −1.25017E−03 | −1.12840E−03 | 1.16052E−04 | −3.52543E−06 |
| 5 | −2.70728E−01 | 1.27211E−02 | 1.93895E−04 | −2.63428E−04 | 0.00000E+00 | 0.00000E+00 |
| 6 | 0.00000E+00 | 3.78411E−02 | 5.99255E−03 | 0.00000E+00 | 0.00000E+00 | 0.00000E+00 |
| 8 | −2.12783E+01 | 1.46965E−02 | −3.05382E−03 | 0.00000E+00 | 0.00000E+00 | 0.00000E+00 |
| 9 | −9.15902E−01 | 2.19561E−02 | 5.61012E−03 | −1.13058E−03 | 0.00000E+00 | 0.00000E+00 |

### Example 6

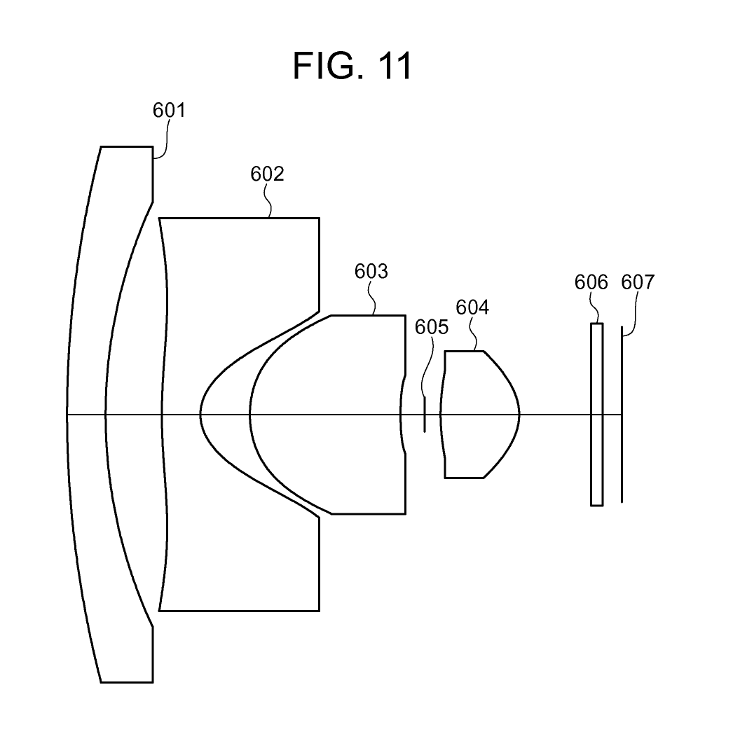

FIG. 11 shows an arrangement of a wide-range optical imaging system according to Example 6. The wide-range optical imaging system according to Example 6 includes, from the object side to the image plane side, a first lens 601, a second lens 602, a third lens 603, an aperture stop 605, and a fourth lens 604. Light which has passed through the first lens 601, the second lens 602, the third lens 603, the aperture stop 605, and the fourth lens 604 passes through a glass plate 606 and reaches an image plane 607.

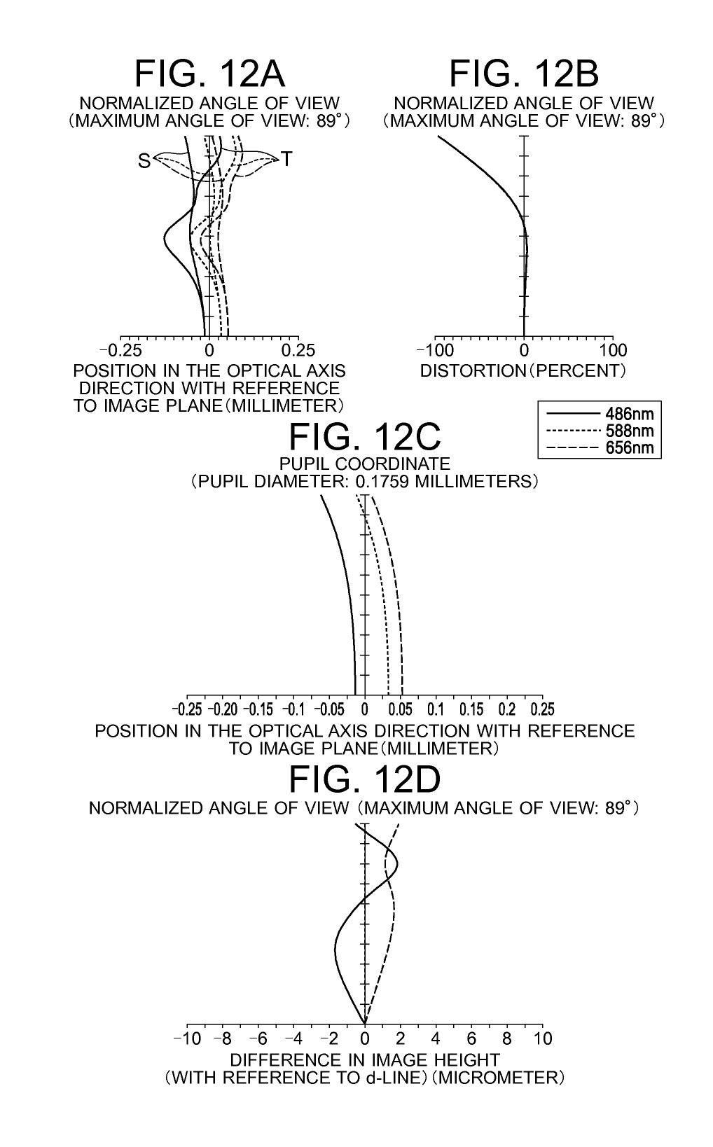

FIGS. 12A to 12D show aberrations of the wide-range optical imaging system according to Example 6. FIG. 12A shows astigmatism. In FIG. 12A, distance (in millimeters) from the image plane to the paraxial image surface is represented as a function of normalized angle of view. The maximum value of normalized angle of view corresponds to 89 degrees. In FIG. 12A, S represents the sagittal image surface while T represents the tangential image surface. FIG. 12B shows distortion. In FIG. 12B, distortion is represented as a function of normalized angle of view. The maximum value of normalized angle of view corresponds to 89 degrees. FIG. 12C shows spherical aberration. In FIG. 12C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.2194 millimeters. FIG. 12D shows chromatic aberration of magnification. In FIG. 12D, image height difference (in micrometer) of each of F-line and C-line with reference to image height of d-line is represented as a function of normalized angle of view. The maximum value of normalized angle of view corresponds to 89 degrees.

Table 13 shows lens data of the wide-range optical imaging system according to Example 6. Surface numbers 1 to 6 represent the object side surface and the image plane side surface of each of the first lens 601, the second lens 602 and the third lens 603, respectively. Surface number 7 represents the aperture stop 605. Surface numbers 8 and 9 represent the object side surface and the image plane side surface of the fourth lens 604, respectively. Surface number 10 represents the object side surface of the glass plate 606, and surface number 11 represents the image plane side surface of the glass plate 606. R represents the radius of curvature in Equation (A) which represents each lens surface. d represents thickness of a lens or the glass plate, or distance between elements. By way of example, the value of d (1.00000) in the row of surface number 1 represents thickness of the first lens 601, and the value of d (1.45955) in the row of surface number 2 represents distance between the first lens 601 and the second lens 602. n represents refractive index at d-line of each lens or element, and v represents an Abbe number at d-line of the material of each lens or element. Unit of length in Table 13 is millimeter.

TABLE 13

| Surface | | | | |
|---|---|---|---|---|
| number | R | d | n | v |
| 1 | 27.71033 | 1.00000 | 1.80400 | 46.57 |
| 2 | 13.01884 | 1.45955 | | |
| 3 | 13.75461 | 1.00000 | 1.52512 | 56.28 |
| 4 | 1.10647 | 1.28331 | | |
| 5 | 2.59395 | 3.90834 | 1.61411 | 25.32 |
| 6 | 7.94643 | 0.62198 | | |
| 7 | ∞ | 0.41613 | | |
| 8 | 4.83107 | 2.03879 | 1.52512 | 56.28 |
| 9 | −1.35219 | 1.86272 | | |
| 10 | ∞ | 0.30000 | 1.51680 | 64.17 |
| 11 | ∞ | 0.50000 | | |

Table 14 shows conic constants and coefficients of the polynomials of the Equation (A) representing the both surfaces of the second to the fourth lenses of Example 6. Since the both surfaces of the first lens 601 are spherical, the conic constants k and the coefficients of the polynomials Ai are zero.

TABLE 14

| Surface | | | | | | |
|---|---|---|---|---|---|---|
| number | k | α4 | α6 | α8 | α10 | α12 |
| 3 | 0.00000E+00 | −2.97552E−03 | 7.13172E−05 | −6.44309E−07 | 0.00000E+00 | 0.00000E+00 |
| 4 | −8.86496E−01 | 9.97494E−03 | −6.90209E−05 | −1.19228E−03 | 1.13045E−04 | −3.65037E−06 |
| 5 | −4.19892E−01 | 1.48154E−02 | 1.86290E−04 | −6.38113E−05 | 0.00000E+00 | 0.00000E+00 |
| 6 | 0.00000E+00 | 4.20669E−02 | 1.15479E−02 | 0.00000E+00 | 0.00000E+00 | 0.00000E+00 |
| 8 | −3.93753E+01 | 1.39544E−02 | −3.11138E−03 | 0.00000E+00 | 0.00000E+00 | 0.00000E+00 |
| 9 | −8.57300E−01 | 1.62311E−02 | 1.46591E−03 | −2.68728E−04 | 0.00000E+00 | 0.00000E+00 |

### Example 7

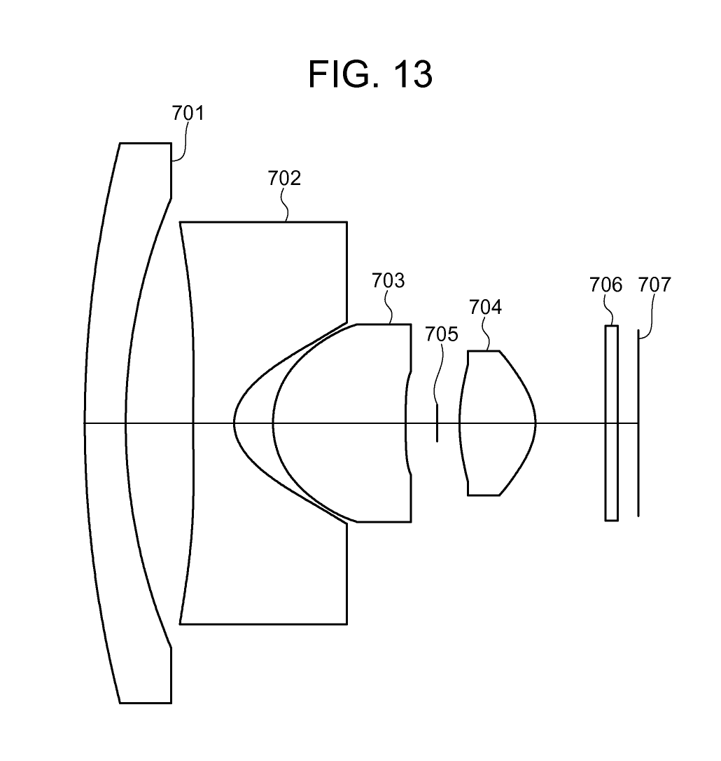

FIG. 13 shows an arrangement of a wide-range optical imaging system according to Example 7. The wide-range optical imaging system according to Example 7 includes, from the object side to the image plane side, a first lens 701, a second lens 702, a third lens 703, an aperture stop 705, and a fourth lens 704. Light which has passed through the first lens 701, the second lens 702, the third lens 703, the aperture stop 705, and the fourth lens 704 passes through a glass plate 706 and reaches an image plane 707.

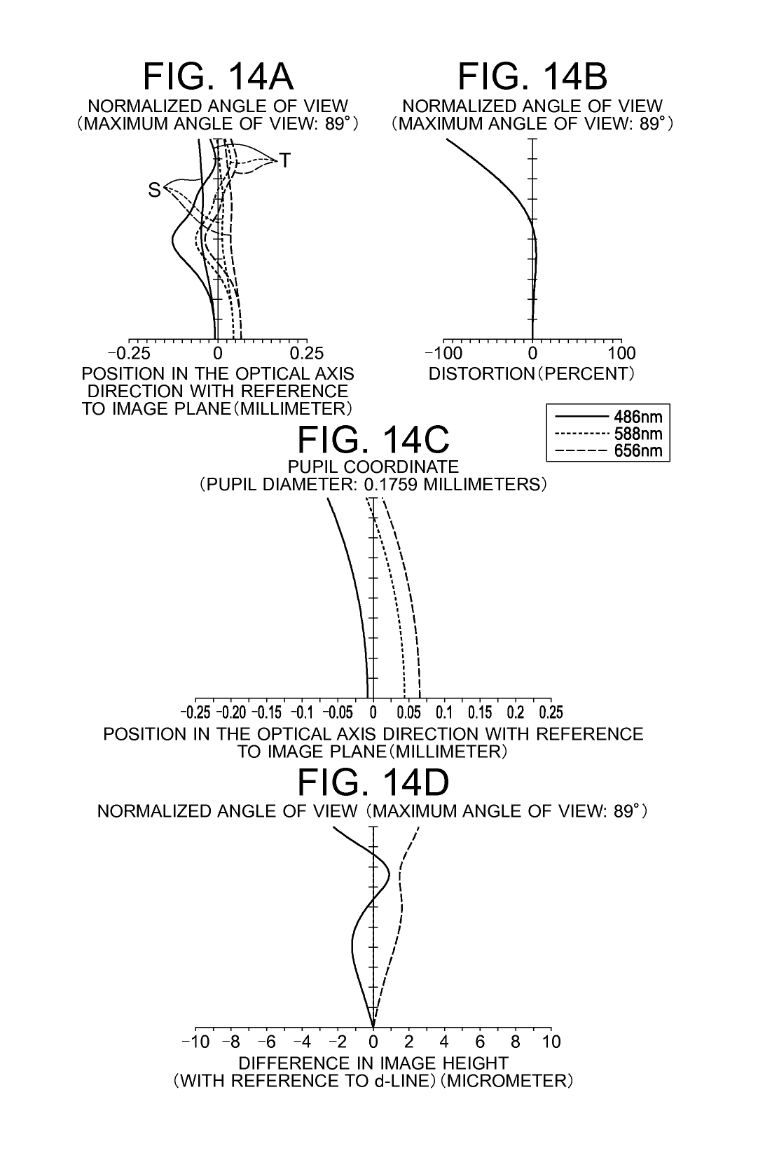

FIGS. 14A to 14D show aberrations of the wide-range optical imaging system according to Example 7. FIG. 14A shows astigmatism. In FIG. 14A, distance (in millimeters) from the image plane to the paraxial image surface is represented as a function of normalized angle of view. The maximum value of normalized angle of view corresponds to 89 degrees. In FIG. 14A, S represents the sagittal image surface while T represents the tangential image surface. FIG. 14B shows distortion. In FIG. 14B, distortion is represented as a function of normalized angle of view. The maximum value of normalized angle of view corresponds to 89 degrees. FIG. 14C shows spherical aberration. In FIG. 14C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.2203 millimeters. FIG. 14D shows chromatic aberration of magnification. In FIG. 14D, image height difference (in micrometer) of each of F-line and C-line with reference to image height of d-line is represented as a function of normalized angle of view. The maximum value of normalized angle of view corresponds to 89 degrees.

Table 15 shows lens data of the wide-range optical imaging system according to Example 7. Surface numbers 1 to 6 represent the object side surface and the image plane side surface of each of the first lens 701, the second lens 702 and the third lens 703, respectively. Surface number 7 represents the aperture stop 705. Surface numbers 8 and 9 represent the object side surface and the image plane side surface of the fourth lens 704, respectively. Surface number 10 represents the object side surface of the glass plate 706, and surface number 11 represents the image plane side surface of the glass plate 706. R represents the radius of curvature in Equation (A) which represents each lens surface. d represents thickness of a lens or the glass plate, or distance between elements. By way of example, the value of d (1.00000) in the row of surface number 1 represents thickness of the first lens 701, and the value of d (1.65090) in the row of surface number 2 represents distance between the first lens 701 and the second lens 702. n represents refractive index at d-line of each lens or element, and v represents an Abbe number at d-line of the material of each lens or element. Unit of length in Table 15 is millimeter.

TABLE 15

| Surface | | | | |
|---|---|---|---|---|
| number | R | d | n | v |
| 1 | 27.35113 | 1.00000 | 1.80400 | 46.57 |
| 2 | 14.05922 | 1.65090 | | |
| 3 | 68.87686 | 1.00000 | 1.52512 | 56.28 |
| 4 | 0.97437 | 0.94944 | | |
| 5 | 2.21926 | 3.24120 | 1.61411 | 25.32 |
| 6 | 41.27478 | 0.77280 | | |
| 7 | ∞ | 0.54338 | | |
| 8 | 4.38156 | 1.85566 | 1.52512 | 56.28 |
| 9 | −1.43698 | 1.71384 | | |
| 10 | ∞ | 0.30000 | 1.51680 | 64.17 |
| 11 | ∞ | 0.50000 | | |

Table 16 shows conic constants and coefficients of the polynomials of the Equation (A) representing the both surfaces of the second to the fourth lenses of Example 7. Since the both surfaces of the first lens 701 are spherical, the conic constants k and the coefficients of the polynomials Ai are zero.

TABLE 16

| Surface | | | | | | |
|---|---|---|---|---|---|---|
| number | k | α4 | α6 | α8 | α10 | α12 |
| 3 | 0.00000E+00 | −2.35577E−03 | 9.89470E−05 | −1.73543E−06 | 1.54087E−09 | 2.59811E−10 |
| 4 | −8.70889E−01 | −1.16524E−02 | −1.03014E−03 | −1.15553E−03 | 1.12473E−04 | −6.26676E−06 |
| 5 | −2.03752E−01 | 9.24031E−03 | 3.49531E−04 | −3.52603E−04 | 0.00000E+00 | 0.00000E+00 |
| 6 | 0.00000E+00 | 3.42814E−02 | −8.94593E−04 | 3.90563E−03 | 0.00000E+00 | 0.00000E+00 |
| 8 | −7.42499E+00 | 3.00377E−03 | −5.68834E−04 | −3.60652E−04 | 0.00000E+00 | 0.00000E+00 |
| 9 | −2.36160E+00 | −3.61764E−02 | 1.69052E−02 | −2.76105E−03 | 0.00000E+00 | 0.00000E+00 |

### Example 8

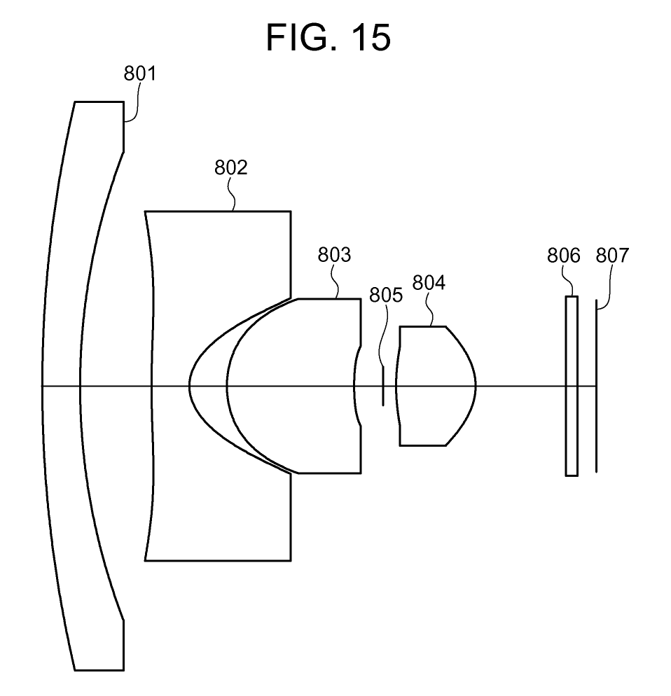

FIG. 15 shows an arrangement of a wide-range optical imaging system according to Example 8. The wide-range optical imaging system according to Example 8 includes, from the object side to the image plane side, a first lens 801, a second lens 802, a third lens 803, an aperture stop 805, and a fourth lens 804. Light which has passed through the first lens 801, the second lens 802, the third lens 803, the aperture stop 805, and the fourth lens 804 passes through a glass plate 806 and reaches an image plane 807.

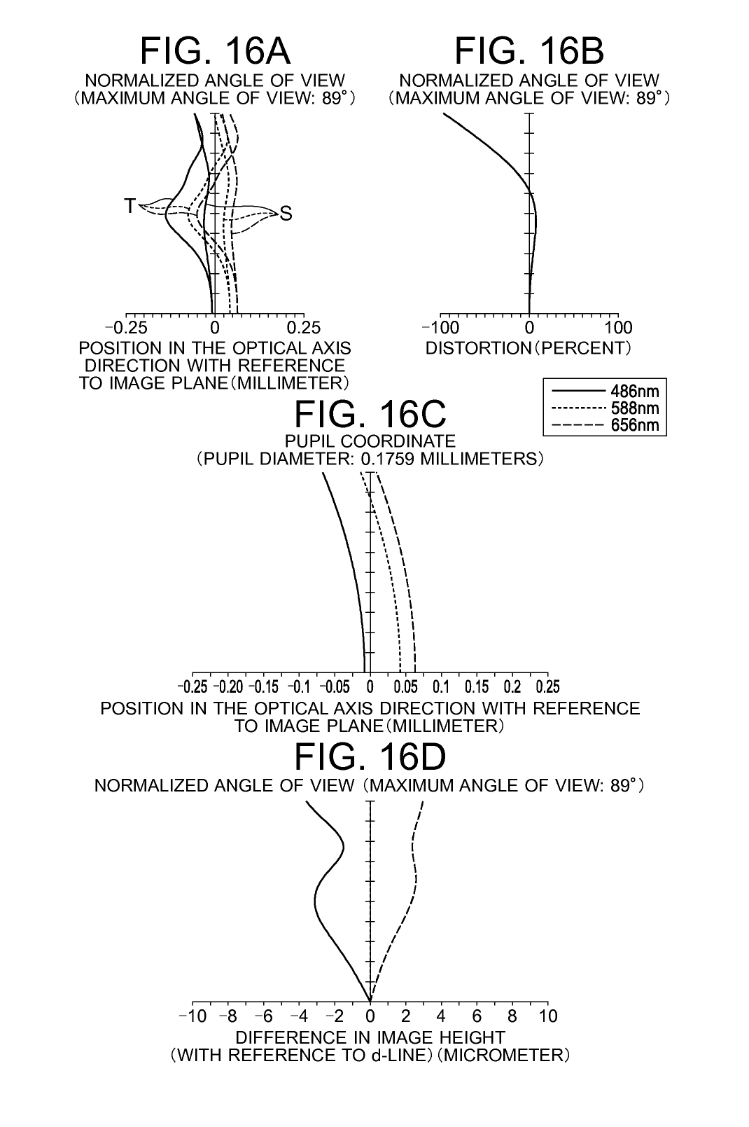

FIGS. 16A to 16D show aberrations of the wide-range optical imaging system according to Example 8. FIG. 16A shows astigmatism. In FIG. 16A, distance (in millimeters) from the image plane to the paraxial image surface is represented as a function of normalized angle of view. The maximum value of normalized angle of view corresponds to 89 degrees. In FIG. 16A, S represents the sagittal image surface while T represents the tangential image surface. FIG. 16B shows distortion. In FIG. 16B, distortion is represented as a function of normalized angle of view. The maximum value of normalized angle of view corresponds to 89 degrees. FIG. 16C shows spherical aberration. In FIG. 16C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.2149 millimeters. FIG. 16D shows chromatic aberration of magnification. In FIG. 16D, image height difference (in micrometer) of each of F-line and C-line with reference to image height of d-line is represented as a function of normalized angle of view. The maximum value of normalized angle of view corresponds to 89 degrees.

Table 17 shows lens data of the wide-range optical imaging system according to Example 8. Surface numbers 1 to 6 represent the object side surface and the image plane side surface of each of the first lens 801, the second lens 802 and the third lens 803, respectively. Surface number 7 represents the aperture stop 805. Surface numbers 8 and 9 represent the object side surface and the image plane side surface of the fourth lens 804, respectively. Surface number 10 represents the object side surface of the glass plate 806, and surface number 11 represents the image plane side surface of the glass plate 806. R represents the radius of curvature in Equation (A) which represents each lens surface. d represents thickness of a lens or the glass plate, or distance between elements. By way of example, the value of d (1.00000) in the row of surface number 1 represents thickness of the first lens 801, and the value of d (1.56238) in the row of surface number 2 represents distance between the first lens 801 and the second lens 802. n represents refractive index at d-line of each lens or element, and v represents an Abbe number at d-line of the material of each lens or element. Unit of length in Table 17 is millimeter.

TABLE 17

| Surface | | | | |
|---|---|---|---|---|
| number | R | d | n | v |
| 1 | 32.84835 | 1.00000 | 1.80400 | 46.57 |
| 2 | 17.22412 | 1.56238 | | |
| 3 | 36.17811 | 1.00000 | 1.52512 | 56.28 |
| 4 | 0.95701 | 1.01209 | | |
| 5 | 2.35021 | 3.30349 | 1.61411 | 25.32 |
| 6 | 13.86311 | 0.76606 | | |
| 7 | ∞ | 0.51293 | | |
| 8 | 4.32708 | 1.89289 | 1.52512 | 56.28 |
| 9 | −1.42727 | 1.87056 | | |
| 10 | ∞ | 0.30000 | 1.51680 | 64.17 |
| 11 | ∞ | 0.50000 | | |

Table 18 shows conic constants and coefficients of the polynomials of the Equation (A) representing the both surfaces of the second to the fourth lenses of Example 8. Since the both surfaces of the first lens 801 are spherical, the conic constants k and the coefficients of the polynomials Ai are zero.

TABLE 18

| Surface | | | | | | |
|---|---|---|---|---|---|---|
| number | k | α4 | α6 | α8 | α10 | α12 |
| 3 | 0.00000E+00 | −2.41591E−03 | 9.68422E−05 | −1.77092E−06 | 1.60303E−09 | 3.01185E−10 |
| 4 | −8.76398E−01 | −1.49919E−02 | −3.27279E−04 | −1.10838E−03 | 1.12054E−04 | −7.30915E−06 |
| 5 | −1.18950E−01 | 9.89425E−03 | 1.43611E−04 | −2.41306E−04 | 0.00000E+00 | 0.00000E+00 |
| 6 | 0.00000E+00 | 3.74205E−02 | 9.43402E−04 | 3.95133E−03 | 0.00000E+00 | 0.00000E+00 |
| 8 | −5.87569E+00 | 2.70169E−03 | −1.15503E−03 | −1.33142E−04 | 0.00000E+00 | 0.00000E+00 |
| 9 | −2.35215E+00 | −3.71341E−02 | 1.67916E−02 | −2.69036E−03 | 0.00000E+00 | 0.00000E+00 |

### Example 9

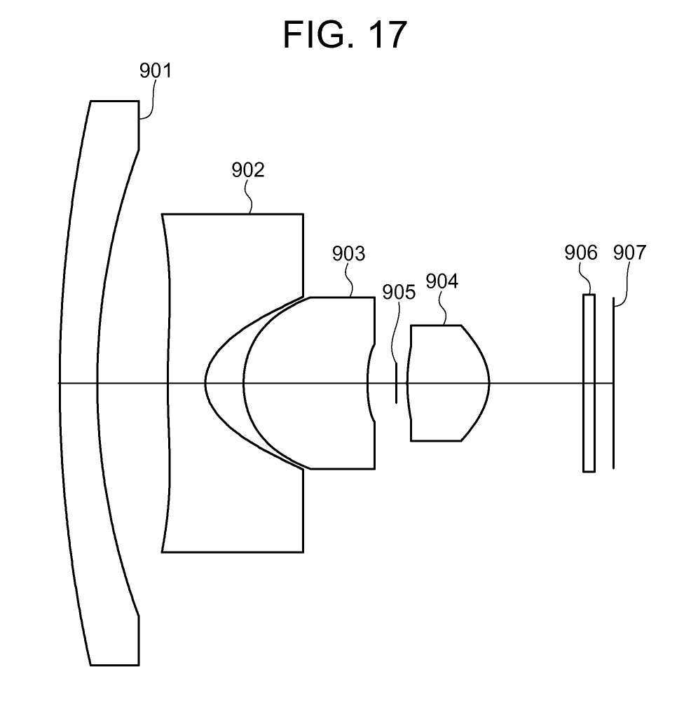

FIG. 17 shows an arrangement of a wide-range optical imaging system according to Example 9. The wide-range optical imaging system according to Example 9 includes, from the object side to the image plane side, a first lens 901, a second lens 902, a third lens 903, an aperture stop 905, and a fourth lens 904. Light which has passed through the first lens 901, the second lens 902, the third lens 903, the aperture stop 905, and the fourth lens 904 passes through a glass plate 906 and reaches an image plane 907.

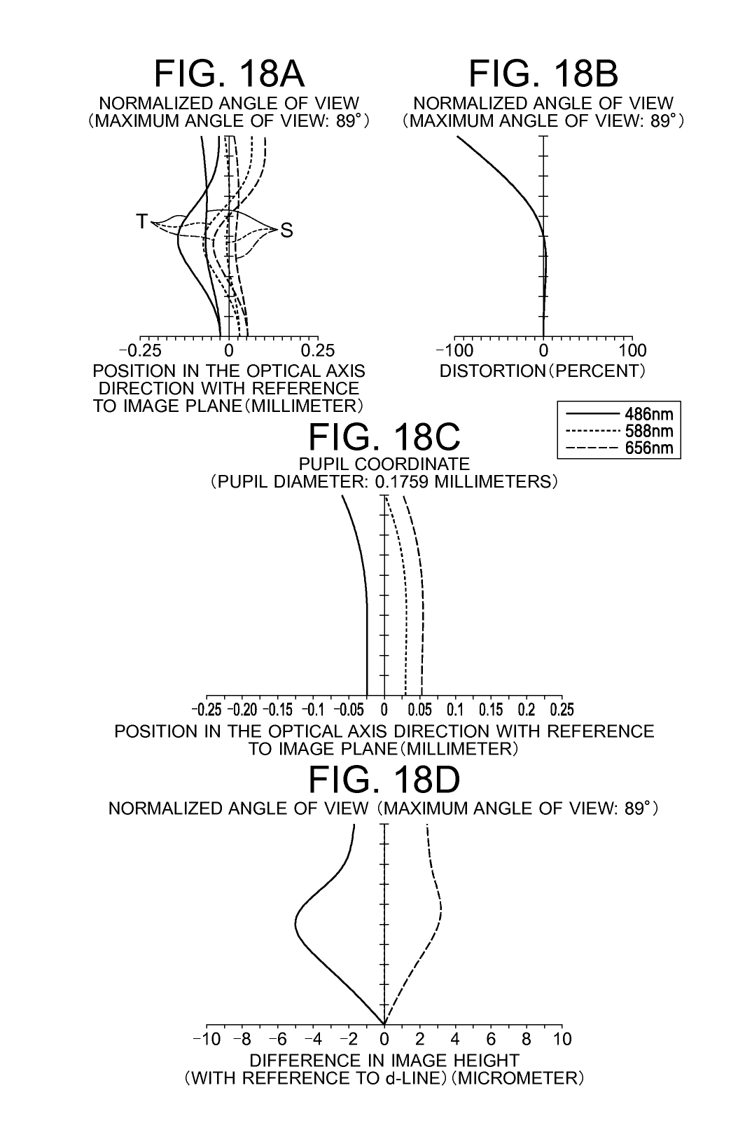

FIGS. 18A to 18D show aberrations of the wide-range optical imaging system according to Example 9. FIG. 18A shows astigmatism. In FIG. 18A, distance (in millimeters) from the image plane to the paraxial image surface is represented as a function of normalized angle of view. The maximum value of normalized angle of view corresponds to 89 degrees. In FIG. 18A, S represents the sagittal image surface while T represents the tangential image surface. FIG. 18B shows distortion. In FIG. 18B, distortion is represented as a function of normalized angle of view. The maximum value of normalized angle of view corresponds to 89 degrees. FIG. 18C shows spherical aberration. In FIG. 18C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.2512 millimeters. FIG. 18D shows chromatic aberration of magnification. In FIG. 18D, image height difference (in micrometer) of each of F-line and C-line with reference to image height of d-line is represented as a function of normalized angle of view. The maximum value of normalized angle of view corresponds to 89 degrees.

Table 19 shows lens data of the wide-range optical imaging system according to Example 9. Surface numbers 1 to 6 represent the object side surface and the image plane side surface of each of the first lens 901, the second lens 902 and the third lens 903, respectively. Surface number 7 represents the aperture stop 905. Surface numbers 8 and 9 represent the object side surface and the image plane side surface of the fourth lens 904, respectively. Surface number 10 represents the object side surface of the glass plate 906, and surface number 11 represents the image plane side surface of the glass plate 906. R represents the radius of curvature in Equation (A) which represents each lens surface. d represents thickness of a lens or the glass plate, or distance between elements. By way of example, the value of d (1.00000) in the row of surface number 1 represents thickness of the first lens 901, and the value of d (1.87630) in the row of surface number 2 represents distance between the first lens 901 and the second lens 902. n represents refractive index at d-line of each lens or element, and v represents an Abbe number at d-line of the material of each lens or element. Unit of length in Table 19 is millimeter.

TABLE 19

| Surface | | | | |
|---|---|---|---|---|
| number | R | d | n | v |
| 1 | 34.68339 | 1.00000 | 1.80400 | 46.57 |
| 2 | 17.98798 | 1.87630 | | |
| 3 | 22.99130 | 1.00000 | 1.52512 | 56.28 |
| 4 | 1.07363 | 1.01983 | | |
| 5 | 2.52174 | 3.29986 | 1.61411 | 25.32 |
| 6 | 4.82586 | 0.77129 | | |
| 7 | ∞ | 0.28999 | | |
| 8 | 4.44392 | 2.17685 | 1.52512 | 56.28 |
| 9 | −1.49653 | 2.51254 | | |
| 10 | ∞ | 0.30000 | 1.51680 | 64.17 |
| 11 | ∞ | 0.50000 | | |

Table 20 shows conic constants and coefficients of the polynomials of Equation (A) representing the both surfaces of the second to the fourth lenses of Example 9. Since the both surfaces of the first lens 901 are spherical, the conic constants k and the coefficients of the polynomials Ai are zero.

TABLE 20

| Surface | | | | | | |
|---|---|---|---|---|---|---|
| number | k | α4 | α6 | α8 | α10 | α12 |
| 3 | 0.00000E+00 | −2.54218E−03 | 6.38775E−05 | −5.16375E−07 | 0.00000E+00 | 0.00000E+00 |
| 4 | −8.80556E−01 | −2.82753E−03 | 1.54520E−03 | −9.90661E−04 | 1.17042E−04 | −9.44078E−06 |
| 5 | −1.52064E−01 | 1.32350E−02 | −2.72710E−04 | 1.88632E−04 | 0.00000E+00 | 0.00000E+00 |
| 6 | 0.00000E+00 | 4.21157E−02 | 1.98431E−02 | 0.00000E+00 | 0.00000E+00 | 0.00000E+00 |
| 8 | −3.59698E+01 | 2.29596E−02 | −4.72105E−03 | 0.00000E+00 | 0.00000E+00 | 0.00000E+00 |
| 9 | −7.73343E−01 | 1.38362E−02 | 9.77197E−04 | 2.47537E−04 | 0.00000E+00 | 0.00000E+00 |

### Example 10

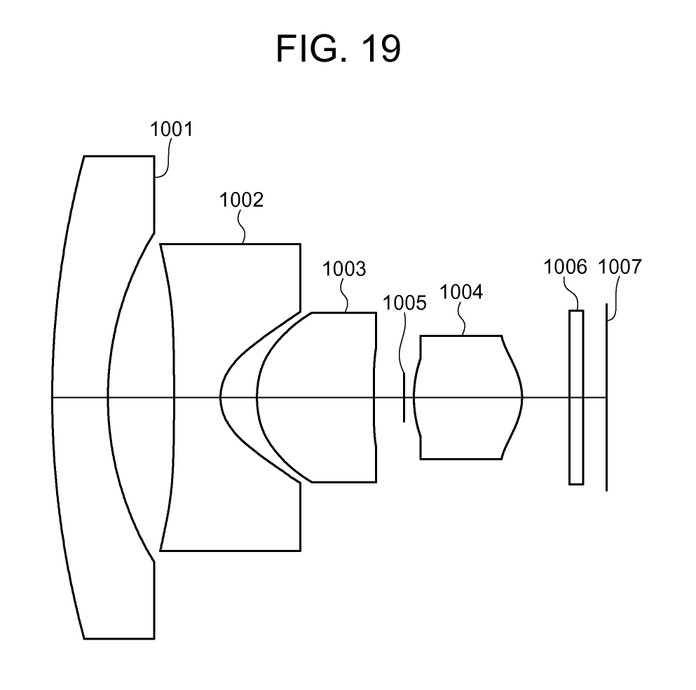

FIG. 19 shows an arrangement of a wide-range optical imaging system according to Example 10. The wide-range optical imaging system according to Example 10 includes, from the object side to the image plane side, a first lens 1001, a second lens 1002, a third lens 1003, an aperture stop 1005, and a fourth lens 1004. Light which has passed through the first lens 1001, the second lens 1002, the third lens 1003, the aperture stop 1005, and the fourth lens 1004 passes through a glass plate 1006 and reaches an image plane 1007.

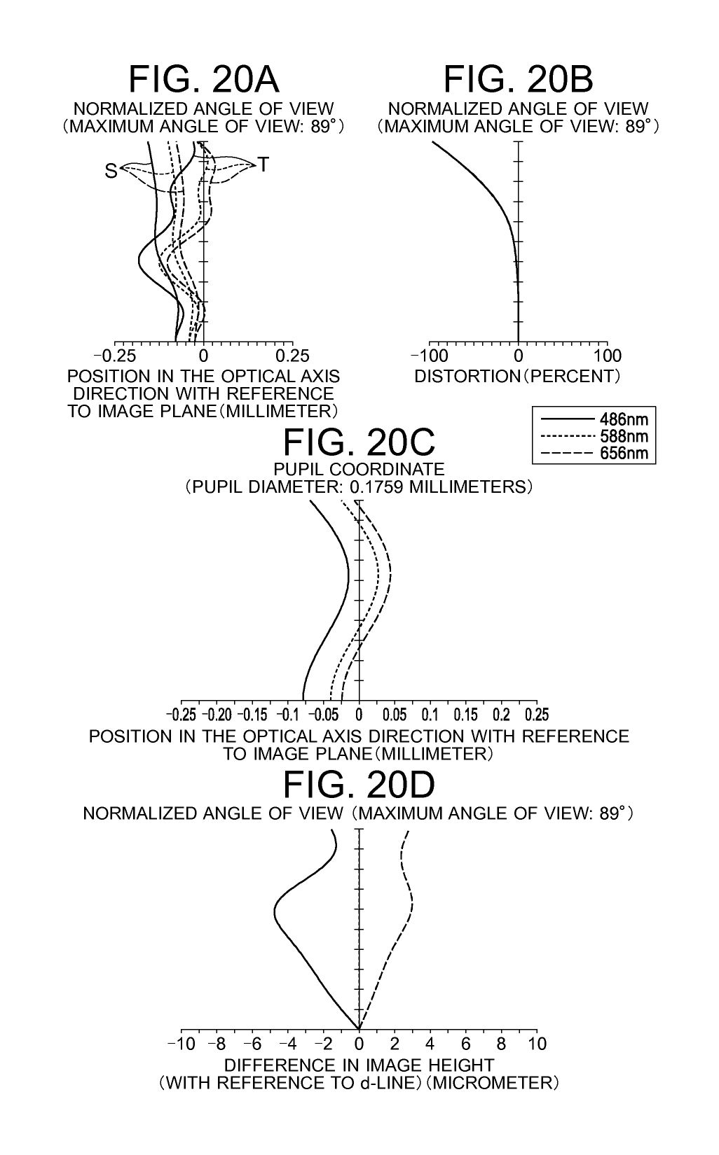

FIGS. 20A to 20D show aberrations of the wide-range optical imaging system according to Example 10. FIG. 20A shows astigmatism. In FIG. 20A, distance (in millimeters) from the image plane to the paraxial image surface is represented as a function of normalized angle of view. The maximum value of normalized angle of view corresponds to 89 degrees. In FIG. 20A, S represents the sagittal image surface while T represents the tangential image surface. FIG. 20B shows distortion. In FIG. 20B, distortion is represented as a function of normalized angle of view. The maximum value of normalized angle of view corresponds to 89 degrees. FIG. 20C shows spherical aberration. In FIG. 20C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.2509 millimeters. FIG. 20D shows chromatic aberration of magnification. In FIG. 20D, image height difference (in micrometer) of each of F-line and C-line with reference to image height of d-line is represented as a function of normalized angle of view. The maximum value of normalized angle of view corresponds to 89 degrees.

Table 21 shows lens data of the wide-range optical imaging system according to Example 10. Surface numbers 1 to 6 represent the object side surface and the image plane side surface of each of the first lens 1001, the second lens 1002 and the third lens 1003, respectively. Surface number 7 represents the aperture stop 1005. Surface numbers 8 and 9 represent the object side surface and the image plane side surface of the fourth lens 1004, respectively. Surface number 10 represents the object side surface of the glass plate 1006, and surface number 11 represents the image plane side surface of the glass plate 1006. R represents the radius of curvature in Equation (A) which represents each lens surface. d represents thickness of a lens or the glass plate, or distance between elements. By way of example, the value of d (1.20000) in the row of surface number 1 represents thickness of the first lens 1001, and the value of d (1.42500) in the row of surface number 2 represents distance between the first lens 1001 and the second lens 1002. n represents refractive index at d-line of each lens or element, and v represents an Abbe number at d-line of the material of each lens or element. Unit of length in Table 21 is millimeter.

TABLE 21

| Surface | | | | |
|---|---|---|---|---|
| number | R | d | n | v |
| 1 | 19.98824 | 1.20000 | 1.79999 | 29.84 |
| 2 | 6.81679 | 1.42500 | | |
| 3 | −66.66544 | 1.00000 | 1.52512 | 56.28 |
| 4 | 1.03328 | 0.78600 | | |
| 5 | 2.26766 | 2.52000 | 1.61411 | 25.32 |
| 6 | −23.86513 | 0.65000 | | |
| 7 | ∞ | 0.21000 | | |
| 8 | 2.41680 | 2.33000 | 1.52512 | 56.28 |
| 9 | −1.26398 | 1.02000 | | |
| 10 | ∞ | 0.30000 | 1.51680 | 64.17 |
| 11 | ∞ | 0.50000 | | |

Table 22 shows conic constants and coefficients of the polynomials of Equation (A) representing the both surfaces of the second to the fourth lenses of Example 10. Since the both surfaces of the first lens 1001 are spherical, the conic constants k and the coefficients of the polynomials Ai are zero.

TABLE 22

| Surface | | | | | | |
|---|---|---|---|---|---|---|
| number | k | α4 | α6 | α8 | α10 | α12 |
| 3 | 0.00000E+00 | −4.23779E−04 | −5.54694E−04 | 4.09594E−05 | 1.34478E−06 | −1.38659E−07 |
| 4 | −1.22720E+00 | 1.32346E−01 | −4.15241E−02 | −5.47769E−03 | 3.98464E−03 | −4.37293E−04 |
| 5 | −2.14572E−02 | 7.59370E−02 | −3.40240E−02 | 1.04045E−02 | −2.16403E−03 | 2.10608E−04 |
| 6 | 0.00000E+00 | 9.78230E−02 | −1.10081E−01 | 1.50493E−01 | −1.17334E−01 | 3.48643E−02 |
| 8 | 3.38431E−01 | −9.83116E−02 | 4.15837E−01 | −9.56059E−01 | 1.10356E+00 | −5.01897E−01 |
| 9 | −9.49515E+00 | −3.57088E−01 | 5.21990E−01 | −3.99269E−01 | 1.65993E−01 | −2.76393E−02 |

### Example 11

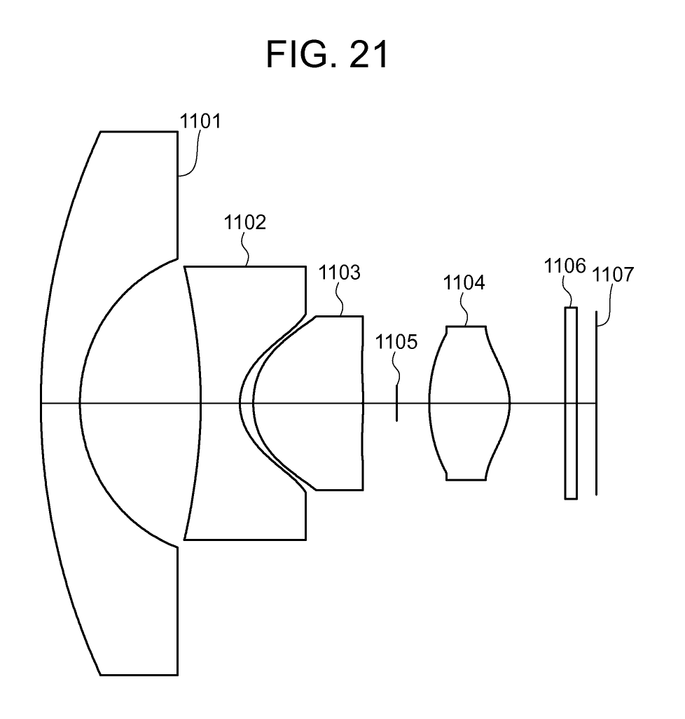

FIG. 21 shows an arrangement of a wide-range optical imaging system according to Example 11. The wide-range optical imaging system according to Example 11 includes, from the object side to the image plane side, a first lens 1001, a second lens 1002, a third lens 1003, an aperture stop 1005, and a fourth lens 1004. Light which has passed through the first lens 1001, the second lens 1002, the third lens 1003, the aperture stop 1005, and the fourth lens 1004 passes through a glass plate 1106 and reaches an image plane 1107.

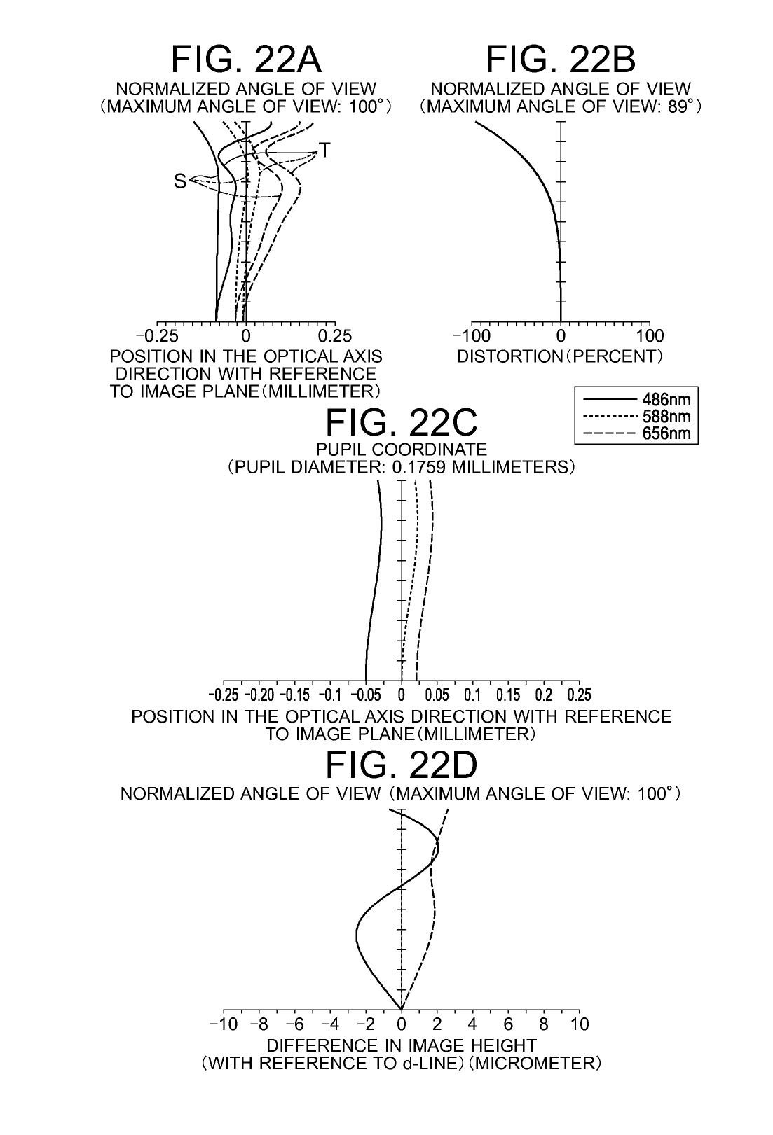

FIGS. 22A to 22D show aberrations of the wide-range optical imaging system according to Example 11. FIG. 22A shows astigmatism. In FIG. 22A, distance (in millimeters) from the image plane to the paraxial image surface is represented as a function of normalized angle of view. The maximum value of normalized angle of view corresponds to 100 degrees. In FIG. 22A, S represents the sagittal image surface while T represents the tangential image surface. FIG. 22B shows distortion. In FIG. 22B, distortion is represented as a function of normalized angle of view. The maximum value of normalized angle of view corresponds to 89 degrees. The maximum angle of view is 100 degrees in half angle. However, since distortion cannot be defined for 90 degrees or more, angle of view is normalized by 89 degrees. FIG. 22C shows spherical aberration. In FIG. 22C, for a ray bundle with angle of view of 0 degree, distance (in millimeters) from the image plane to points at which rays of the ray bundle intersect with the optical axis is represented as a function of normalized pupil coordinate. The maximum value of normalized pupil coordinate corresponds to 0.1759 millimeters. FIG. 22D shows chromatic aberration of magnification. In FIG. 22D, image height difference (in micrometer) of each of F-line and C-line with reference to image height of d-line is represented as a function of normalized angle of view. The maximum value of normalized angle of view corresponds to 100 degrees.

Table 23 shows lens data of the wide-range optical imaging system according to Example 11. Surface numbers 1 to 6 represent the object side surface and the image plane side surface of each of the first lens 1101, the second lens 1102 and the third lens 1103, respectively. Surface number 7 represents the aperture stop 1105. Surface numbers 8 and 9 represent the object side surface and the image plane side surface of the fourth lens 1104, respectively. Surface number 10 represents the object side surface of the glass plate 1106, and surface number 11 represents the image plane side surface of the glass plate 1106. R represents the radius of curvature in Equation (A) which represents each lens surface. d represents thickness of a lens or the glass plate, or distance between elements. By way of example, the value of d (1.00000) in the row of surface number 1 represents thickness of the first lens 1101, and the value of d (3.09747) in the row of surface number 2 represents distance between the first lens 1101 and the second lens 1102. n represents refractive index at d-line of each lens or element, and v represents an Abbe number at d-line of the material of each lens or element. Unit of length in Table 23 is millimeter.

TABLE 23

| Surface | | | | |
|---|---|---|---|---|
| number | R | d | n | v |
| 1 | 15.57408 | 1.00000 | 1.80400 | 46.57 |
| 2 | 3.80440 | 3.09747 | | |
| 3 | −11.31314 | 1.00000 | 1.52512 | 56.28 |
| 4 | 1.31541 | 0.34371 | | |
| 5 | 2.06950 | 2.81526 | 1.61411 | 25.32 |
| 6 | −6.65472 | 0.86000 | | |
| 7 | ∞ | 0.83234 | | |
| 8 | 3.73788 | 2.06174 | 1.52512 | 56.28 |
| 9 | −1.50486 | 1.41744 | | |
| 10 | ∞ | 0.30000 | 1.51680 | 64.17 |
| 11 | ∞ | 0.50000 | | |

Table 24 shows conic constants and coefficients of the polynomials of Equation (A) representing the both surfaces of the second to the fourth lenses of Example 11. Since the both surfaces of the first lens 1101 are spherical, the conic constants k and the coefficients of the polynomials Ai are zero.

TABLE 24

| Surface | | | | | | |
|---|---|---|---|---|---|---|
| number | k | α4 | α6 | α8 | α10 | α12 |
| 3 | −5.54890E+01 | −2.26773E−03 | 2.18198E−04 | −9.22124E−06 | 0.00000E+00 | 0.00000E+00 |
| 4 | −7.38061E−01 | 7.87204E−03 | −1.88960E−03 | −1.71441E−03 | 5.72044E−05 | 5.55846E−06 |
| 5 | −3.52456E−01 | 3.82096E−02 | −4.18552E−03 | −5.14153E−04 | 0.00000E+00 | 0.00000E+00 |
| 6 | −2.51134E+02 | 1.11483E−02 | 1.00709E−03 | 0.00000E+00 | 0.00000E+00 | 0.00000E+00 |
| 8 | −2.58306E+00 | 7.17679E−03 | 2.48357E−04 | 0.00000E+00 | 0.00000E+00 | 0.00000E+00 |
| 9 | −1.54839E+00 | 2.43559E−02 | 3.15157E−03 | −4.21975E−04 | 0.00000E+00 | 0.00000E+00 |

### Comparison Between Aberrations of Examples of the Present Invention and Aberrations of Examples of JP2006259704A

As described below, values of longitudinal chromatic aberration and chromatic aberration of magnification of examples of the present invention are made smaller than those of examples of JP2006259704A. Values of distortion of examples of the present invention are greater than those of examples of JP2006259704A. The reason is that the maximum angle of view of Examples 1 to 10 of the present invention is 179.6 degrees (89.8 degrees in half angle) and the maximum angle of view of Example 11 is 200 degrees (100 degrees in half angle) while the maximum angle of examples of JP2006259704A rages from 139.4 (69.7 degrees in half angle) degrees to 165.2 degrees (82.6 degrees in half angle). Thus, the present invention is applicable to a wider angle of view than the value of angle of view to which conventional optical systems are applicable.

### Longitudinal Chromatic Aberration

According to FIG. 2C and other drawings, longitudinal chromatic aberration of Examples 1 to 11 of the present invention remains within limits of ±0.1 millimeters. On the other hand, longitudinal chromatic aberration of Examples 1 to 12 of JP2006259704A does not remain within limits of ±0.1 millimeters, but is within limits of ±0.25 millimeters.

### Chromatic Aberration of Magnification

According to FIG. 2D and other drawings, chromatic aberration of magnification of Examples 1 to 11 of the present invention remains within limits of ±5 micrometers. On the other hand, chromatic aberration of magnification of Examples 1 to 12 of JP2006259704A does not remain within limits of ±5 micrometers, but is within limits of ±10 micrometers.

What is claimed is:

1. A wide-range optical imaging system comprising a first lens, a second lens, a third lens, an aperture stop, and a fourth lens, arranged from the object side to the image plane side, the first lens being a negative meniscus lens having a convex surface on the object side, the second lens being negative, the third lens being positive and the fourth lens being positive,
wherein when Abbe numbers for a d-line of the second to the fourth lenses are represented respectively by v₂, v₃ and v₄, the expressions
v2>35 (1)
v3<45 (2)
v4>35 (3)
v2−v3≧10 (4)
v4−v3≧10 (5)
are satisfied, and
when a focal length of the second lens is represented as f2, a focal length of the third lens is represented as f3, and a focal length of the whole optical system is represented as f, the expressions
−2.3≦f2/f≦−1.5 (6)
3.0≦f3/f≦4.0 (7)
are satisfied.

2. A wide-range optical imaging system according to claim 1, wherein the expressions
v2≧50 (8)
v3≦30 (9)
v4≧50 (10)
v2−v3≧20 (11)
v4−v3≧20 (12)
are further satisfied.

3. A wide-range optical imaging system according to claim 1, wherein when a focal length of the fourth lens is represented as f4, the expression
1.72≦f4/f≦2.45 (13)
is satisfied.

4. A wide-range optical imaging system according to claim 1, wherein the image plane side surface of the second lens is concave, the object side surface of the third lens is convex, and the both surfaces of the fourth lens are convex.

5. A wide-range optical imaging system according to claim 4, wherein the edge of the object side surface of the second lens is configured to be warped toward the object side.

6. A wide-range optical imaging system according to claim 4, wherein the image plane side surface of the second lens and the object side surface of the third lens are configured such that among rays in a ray bundle that forms an image at the maximum image height, the further from the optical axis a position of a ray, the greater the traveling distance of the ray between the two surfaces around the edges of the two surfaces becomes.

7. A wide-range optical imaging system according to claim 5, wherein the image plane side surface of the second lens and the object side surface of the third lens are configured such that among rays in a ray bundle that forms an image at the maximum image height, the further from the optical axis a position of a ray, the greater the traveling distance of the ray between the two surfaces around the edges of the two surfaces becomes.

8. A wide-range optical imaging system according to claim 7, wherein when a coordinate representing a position in the direction of the optical axis of a point on a lens surface with reference to the intersection point of the lens surface and the optical axis is represented as z, a sign of z is set to be positive on the image plane side, a distance between the point on the lens surface and the optical axis is represented as r, and the lens surface is represented as
z=f(r),
where f(x) represents a function of x, a sign of the second derivative of the above-described function around the optical axis of the image plane side surface of the second lens differs from a sign of the second derivative of the above-described function at the periphery of a circle having a diameter of 0.9 of the effective diameter of the image plane side surface of the second lens.

9. A wide-range optical imaging system according to claim 1, wherein the expressions
−2.3≦f2/f≦−1.9 (14)
3.0≦f3/f≦3.5 (15)
are further satisfied.

10. A wide-range optical imaging system according to claim 1, wherein the maximum angle of view (in full angle) is 170 degrees or more.

11. A wide-range optical imaging system according to claim 1, wherein the maximum angle of view (in full angle) is 180 degrees or more.
